(19) United States
(12) Patent Application Publication
(10) Pub. No.: US 2015/0032801 A1
(43) Pub. Date: Jan. 29, 2015

(54) SIMULTANEOUS EVENTS OVER A NETWORK

(71) Applicant: Matthew Bryan Hart, Berwyn Heights, MD (US)

(72) Inventor: Matthew Bryan Hart, Berwyn Heights, MD (US)

(21) Appl. No.: 13/953,237

(22) Filed: Jul. 29, 2013

(51) Int. Cl. H04L 29/08

(52) U.S. Cl. CPC H04L 67/10
USPC 709/203

(57) ABSTRACT

The present disclosure relates to a technique for causing the simultaneous initiation of events over multiple devices over a network such that the events begin at a predetermined instant in time, within a precisely defined time window relative to the plurality of devices. The present method and system provides that for a given predetermined instant in time, a witness able to observe all the devices concurrently would note that the plurality of devices would individually begin an activity within a specified time window. The instant in time, t₀, is a predetermined moment in the future. The disclosed method and system provides a means to determine a level of confidence to verify that the defined window of simultaneity can be achieved among the plurality of devices prior to the activity taking place. The established level of confidence is based on the statistical nature of data packet transmission over latency limited networks.

### I. BACKGROUND

1.1 Technical Field of the Invention

The present invention relates to mobile telecommunications and internet technology, and more particularly to the method, system and apparatus of providing the initiation of a simultaneous action on multiple network capable devices such as wired or wireless computers and smart phones. As described with more detail herein, the term simultaneous when used within the scope of the present invention describes events that begin within a specifically defined time frame of less than one (1) second, as would be noticed by a witness observing the entire set of devices concurrently, at a predetermined initiation time of the event.

1.2 Description of Related Art

### 1.2.a Problem Solved by the Present Invention

When identical data is concurrently transmitted over a network to multiple data receivers, the data will not arrive at the receivers at the same time unless by coincidence. This is true even when the separate transmissions, directed to all recipients, are initiated at the same moment from a single, centrally located computer server. This precludes the ability for multiple devices to initiate a precisely timed action at the same moment using direct commands by a central server over a typical network at the time that the event is to take place. An example is that a text message sent by a single user to multiple other users concurrently (in parallel) will be received by the other devices separately in time, over a time-span typically ranging from a few seconds to a few minutes. If a pair, or less likely more than two, of the receiving devices obtain that text message at the “exact” same time it is by coincidence only. Commonly, the interpretation of terms such as “exact” and “simultaneous” are not rigorous, and vary depending on the constraints and urgency of the situation. Hereinafter, the specific intended meaning of such terms is defined explicitly for use in the present invention.

The present method and system is a means to perform very precise simultaneous event initiations across many network capable devices that may be separated across a potentially vast, latency limited network. Furthermore, the simultaneous actions are orchestrated within a strictly defined time span that is less than one second among the plurality of devices along with a statistically based confidence metric, both of which are designated before the action is to take place. The outcome of this method and system is achieved using a systematic approach to overcome inconsistent local device timing mechanisms and by dynamically determining the limits of the current network conditions for each device.

1.2.b Challenges Addressed by this Invention

There are many mechanisms at play that normally cause the inability of events to occur with precise timing over a network. Three principal mechanisms for this are: (i) The different physical routes that the data transmissions may take create different lag times between sent and received data, also known as network latency by those skilled in the art, (ii) the variance of the network latencies created by dynamically changing network conditions, and (iii) the inaccuracies of the local timing mechanisms operating within individual devices.

Signals that carry information between electronic devices over the internet by a wired or wireless communication system suffer from various forms of delay that accumulate into the overall latency of the information that is being transferred over the network. Data transmission times are reported by sources [REFS. 6, 7 & 8] that have average latency across North America that are typically less than 100 milliseconds and less than 150 milliseconds across the Atlantic or Pacific from the United States. A millisecond (ms) is a thousandth ( 1/1,000) of a second. When networked devices require many relay points, and possibly even earth-orbit satellite routing, the difference in signal travel times can accumulate to several seconds. Latencies are typically greatest for wirelessly connected mobile devices which usually require a connection using cell tower technology that can easily bottleneck during periods of high network traffic. Thus, the information that is simultaneously transmitted from a single source to several distinct devices over the network will arrive at those devices at different times due to the network conditions along the different routes to each device. As will become more clear hereinafter, the actual latencies are not a critical parameter to the present method and system, but rather the variance in the latencies.

Data transmission latencies typically vary over time, and can be effected by, but not limited to, the type of connection, travel distance, the bandwidth of the provided service, and the number of other devices currently using the system resources. Thus, if an identical data transmission is repeatedly sent to a device, it is generally found that the latency will from time to time will be different due to the changing network conditions. As understood by those familiar in the art of network communications, when comparing multiple data transmissions between two devices over a network under nominal conditions, there is a reasonable expectation of the variance in latency to lie in the approximate range from less than 1 ms to about 500 ms (one half of a second).

As described with more detail hereinafter, this method and system employs a series of direct measurements of the data transmission times to determine a statistically based assessment of the network latency variance which is used to verify that the plurality of participating devices can achieve a pre-designated window of simultaneity. Moreover, the acquired data is also used to apply a correction to the server timestamp to produce a more accurate event initiation time for the event for each device on an individual basis.

Networked devices can employ many different methods to acquire data from a network. Two common methods are polling and pushing. Polling requires devices to periodically send a request to a server on the network and then receive data that the server may respond with. The pushing method typically requires a computer server on the network to send data to specific connected devices. In this case, all participating devices must be connected, identifiable and constantly listening for incoming transmissions. Both of these two methods have advantages and disadvantages when it comes to network efficiency and latency issues.

As is detailed hereinafter, the present method and system employs a polling type approach which takes advantage of two features of the method which are (i) it does not require the device to be network connected unless the specific device is requesting information and (ii) the central server plays a more traditional, passive role in the since it merely waits for a device to send a request for information.

Devices used for the embodiments of the present method and system are expected to be of the type that typically have programmed alarms built into their functionality. These alarms rely on the internal clock settings of the device and can be set by either the user or by using a program that causes the device to periodically check the network for a local time stamp to set the clock by. The accuracy, however, of these electronic timing systems can diminish over time with respect to a highly precise time reference due to factors such as temperature and systematic or natural flaws that depend on the particular timing mechanism employed in the specific device. These are commonly based on quartz crystal oscillators and require proper calibrations, adjustments and possibly temperature control to maintain a given accuracy over several hours. When comparing to a highly accurate time keeping source, such as an atomic clock, it is not unusual for such devices to deviate up to several seconds after several hours of continuous operation. A cost effective way to maintain appropriate accuracies for a typical time clock is to periodically synchronize to a more accurate source such as a network time protocol (NTP) server based on Universal Time Coordinated (UTC) as is commonly done with devices that are network capable.

Relying on this type of alarm mechanism to create precisely timed events among several devices is problematic since the internal timing mechanisms of individual devices can vary widely and as mentioned, can differ in accuracy of several seconds over periods of time as short as a few hours. Thus, simply setting alarms to the identical time on a set of devices can result in several second time differences between the actual moment that the alarm initiates on each device, and may depend on how much time has elapsed since the last clock-to-network synchronization. Additionally, since the alarm systems and clock settings can usually be manipulated by the user, errors can be made when attempting to set simultaneous events based on individual alarms over a set of devices especially when several time zones may be involved.

Another means that programmable devices have to monitor timing is based on a high frequency computer processing unit (CPU) oscillator based circuit, which typically maintain precisions better than a nanosecond, that is 10⁻⁹ seconds. Software can be used to monitor the number of relative time steps from this mechanism, or ticks as known by those familiar in the art of computer architecture, and can be used to convert into a more precise relative time. However, it is not reliable as an absolute time alarm since it may be reset at times when the device is turned off or when the cpu goes into a sleep mode as is common for contemporary battery powered devices.

The present method and system does not depend on the absolute time as would be kept by the clock for the user of the device, but rather depends only on relative time, that is, the change in time, provided by the more precise local hardware processor timing data available to the software. Furthermore, since there is a limited amount of time before even the most accurate processor based timing mechanisms start to become inaccurate, local device timing associated with the event initiation time on each device is limited to a set length of time, such as less than two hours. How this aspect is implemented is discussed with more detail hereinafter.

There are many different hardware and software configurations that combine to make up the potential pool of participating devices of the present method and system. As understood by those familiar with network hardware and the art of computer programming, it is reasonable to assume, in this era of multicore processors and instruction timing that is measured in nanoseconds, that typical devices are intrinsically fast enough to react to command instructions from the local software such that each device can perform the activity initiation faster than that defined by the limit of the network latency variance. There may be cases however, where older hardware configurations or software process loading causes a device to react slowly. Those familiar with the art of computer programming appreciate the measures that can be taken to alleviate the slowness or to simply exclude the device from participation subject to the precision requirements of a particular embodiment. It is the experience of the inventor that most programmable, network connectable devices manufactured after 2008 have the ability to react in time scales that are faster than one millisecond, that is, less than 1/1000^{th} of a second, which is shorter than typical minimum latency variances under the best conditions on wireless networks.

### 1.2.c Methods of Network Operation

With any system, mechanical, electrical or otherwise that requires a structure to support the apparatus, certain requirements are assumed pertaining to reasonable quality and consistency to maintain functionality, as is assumed by those skilled in the art of digital network communications. Since there are critical timing issues involved, this aspect is mentioned explicitly. Embodiments of this disclosure rely on the use of pre-existing networks that rely on pre-existing network protocols that are commonly transparent to the average user, which includes, but is not limited to TCP/IP or GSM. Any electronic digital network, wired or wireless is assumed to be available, for limited amounts of time or readily constructed, for the benefits of the present invention to be achieved.

### 1.2.d Protocols and Software

As appreciated by those skilled in the art, there are many communication protocols that are typically used to transmit data across a network. HTTP, FTP, and ICMP are a few examples. The present invention does not require, imply or favor the use of any one particular protocol in association with electronic devices connecting with one another over a network. It is assumed that the protocol used is that which is appropriate to the type of devices used and the type of network available for which the present method and system is to be used. When used herein, the terms “send”, “receive”, “request” and “reply”, when associated with data transmitting between electronic devices in mutual communication over a network, it is reasonable that those skilled in the art will choose an appropriate protocol depending on the specific devices used and network available.

To describe the actions of an electronic device that is controlled by software used to cause an action on the device, no particular type of software is required, implied or favored within the scope of the present invention. There are many possible programming languages that contain the basic network communication command libraries which can be used to perform this duty by those skilled in the art. For example the commonly used languages C, C++, Java, or PHP contain built in subroutines that allow data to be passed from one device to another over the internet. Furthermore, regardless of the form of controlling software employed, the algorithms used to perform the actions of the present method and system can be formulated such that the plurality of devices will achieve the objective, as understood by those familiar in the art of computer programming.

### 1.2.e Data Packets and Segmenting

As known by those skilled in the art of network communication, a common method (or requirement by the protocol being used) to transmit data streams across a network, is through the use of data packets. By breaking large data streams into smaller packets, data can be more efficiently transported through the various electronic routing components and re-assembled at the destination. Data packets transmitted over a network may have a maximum size referred to as a maximum transmission unit (MTU), which is the maximum size a data packet can be to transmit through the network without segmenting. The MTU is network protocol dependent and may not even be defined for some protocols. Specific values of MTU is expected to change as technology evolves without effecting the benefits, use or embodiments of the present invention.

The MTU of the network is pertinent however, to all embodiments of the present invention since sending non-segmented data produces the most accurate synchronized timing of the events. The present method and system employs the use of the smallest set of information to be contained in a data transmission request when polling the central server for transmission timing data. The use of such timing requests will become more clear in the details presented hereinafter.

### 1.2.f Margin of Error of the Latency Variance

The present method and system utilizes statistical methods to determine a quantified level of confidence for the outcome of the present invention by determining the margin of error of the data packet latency (transit times). This is based on the variance of the latency between two network connected devices. It is noted that the distribution of sample means of the latency variance is assumed to follow that of a normal distribution, which is a reasonable approximation as understood by those familiar in the arts of statistics and electronic networks.

Based on the Central Limit Theorem [REF. 4], the mathematical definition of the margin of error for small sample sizes, is the standard deviation of the sample, designated as Sₘ herein, multiplied by a factor that determines the level of confidence as described further in this section. Mathematically, it is stated more concisely as follows. The standard deviation, designated as S herein, is the square root of the variance of the data packet transit times, and Sₘ is S divided by the square root of the number of samples. If the variance of the data packet transit times is designated as νₜₜ, then for N number of measurements of the transit times, the standard deviation, S, is defined by the formula:

$$S = \sqrt{{v}_{tt}} = \sqrt{\frac{1}{N - 1} {\sum }_{t = 1}^{N} {( TT 1 [ i ] - TT 1 )}^{2}} , \qquad ( eqn . 1 )$$

where TT1[i] represents the i^{th} measured transit time, and TT1 is the sample mean transit time of the plurality of measurements, and is defined by

$$TT 1 = \frac{{\sum }_{i = 1}^{N} TT 1 [ i ]}{N} . \qquad ( eqn . 2 )$$

The standard deviation of the sample, Sₘ, for the set of N measurements is:

$${S}_{m} = \frac{S}{\sqrt{N}} . \qquad ( eqn . 3 )$$

As understood by those familiar in the art of statistics, the margin of error of a small set of measurements can be quantified using what is commonly referred to as critical t scores, which are numerical weighting values based on statistical mathematics that are dependent on the number of samples taken and the desired level of confidence. When used herein, t_{N}^{CL} represents the t score for a specific number of samples, N, at a specific level of confidence, CL. The level of confidence is commonly represented as a percentage of complete certainty, ranging from zero (0) percent (no confidence) to 100 percent (highest possible confidence). For example, the notation used herein for a critical t score using 12 measurements at a confidence level of 99 percent is t₁₂⁹⁹.

The values of t_{N}^{CL} can be explicitly computed using statistical distributions, and can be cumbersome, and thus commonly, the values are referenced from a table, as appreciated by those familiar in the art of statistics. TABLE 1 shows critical t scores for sample numbers up to 10 and confidence levels of 99%, 98%, 95%, 90% and 80%.

TABLE 1
Some values of critical t scores, t_{N}^{CL}.

| N | CL = 99% | CL = 98% | CL = 95% | CL = 90% | CL = 80% |
|---|---|---|---|---|---|
| 2 | 63.656 | 31.821 | 12.706 | 6.314 | 3.078 |
| 3 | 9.925 | 6.965 | 4.303 | 2.920 | 1.886 |
| 4 | 5.841 | 4.541 | 3.182 | 2.353 | 1.638 |
| 5 | 4.604 | 3.747 | 2.776 | 2.132 | 1.533 |
| 6 | 4.032 | 3.365 | 2.571 | 2.015 | 1.476 |
| 7 | 3.707 | 3.143 | 2.447 | 1.943 | 1.440 |
| 8 | 3.499 | 2.998 | 2.365 | 1.895 | 1.415 |
| 9 | 3.355 | 2.896 | 2.306 | 1.860 | 1.397 |
| 10 | 3.250 | 2.821 | 2.262 | 1.833 | 1.383 |

When used herein, the designation ME_{CL} is to be understood as the margin of error at a specified confidence level, CL. To compute the margin of error, the value of Sₘ is multiplied by t_{N}^{CL}:

ME_{CL}=Sₘ·t_{N}^{CL} (eqn. 4)

The value of ME_{CL} is used to define the interval for which the mean of the samples can be located at the given level of confidence, that is, for a mean value of TT1, as determined from a small sample, the actual value of the mean lies within the range from (TT1−ME_{CL}) to (TT1+ME_{CL}) with a level of confidence CL. In this way an indication of the variation is quantified to a specified level of confidence based on the standard deviation of the sample. When there is a small number of samples, that is less than about 50, it is common to use this type of analysis to interpret the quality of the mean of the set of values by expressing the margin of error to a stated confidence level. For instance, there is a 95 percent chance that the mean of a set of measurements, TT1, falls within the range from (TT1−ME₉₅) to (TT1+ME₉₅).

The present method and system employs the use of the margin of error, as described in this section, to statistically verify that a device can achieve the designated window of simultaneity by sampling the timing data gathered from a central server as described with more detail hereinafter.

I.3 Advantages and Uses of the Present Invention

Embodiments of the present method and system require a network connection prior to, but not during the actual initiation time of the event, using hardware that is already in common use such as programmable smart phones and personal computers. The disclosed method and system renders networking latencies inconsequential to achieve the objective of the present invention, which is the precise simultaneous initiation of an event on many devices. Additionally, the number of participating devices is unlimited, and can be located anywhere there is a network connection, wired or wireless. As discussed with more detail hereinafter, the present invention utilizes a systematic countdown approach that is based on these key aspects: (i) The use of relative timing, (ii) working within the time accurate ranges of common electronic timing mechanisms, (iii) the determination of statistically quantified confidence levels of the network latency, (iv) time synchronization and network transmission timing using a polling approach to a network reachable server with a data exchange that is independent of the server processing time.

Uses of the present invention are those that utilize an electronically networked based activity that requires a high degree of consistently precise synchronized timing on common non-mobile programmable devices or mobile devices such as smart phones. These activities include, but are not limited to the simultaneous energizing of vastly separated, or near-located electronic circuits for synchronized needs such as robotic manufacturing, precise demolition using explosive arrays, artistic works requiring a timing element such as firework displays or the enhancement of wide area coordinated activities such as social events and competitions, information presentation and sound or music delivery.

Embodiments that achieve timing precisions shorter than one tenth ( 1/10) of a second provide a strict enough synchronization that pre-recorded multi-track music can be used such that different devices play a separate track (instrument), creating a band or orchestra consisting of individual devices assuming the part of single musical instruments.

I.4 Definitions

As an aide to better explain the present invention, the following definitions are provided. If any definition provided herein is inconsistent with a dictionary meaning as commonly understood in the art, or meaning as incorporated by reference to a patent or literature citation, the definition presented here shall prevail. The following definitions apply within the scope of the present invention:

### 1.4.a Simultaneous and Window of Simultaneity

The term “simultaneous” is commonly used for the description of actions happening at the same time, but is frequently suggested without regard to the specific timing, strictness of the timing or to what extent the parallelism in time is constrained. The term “substantially simultaneous” is used to described events happening very close in time, but still without a precise clarification of the descriptor “substantially”. In the case 3M Innovative Properties Company and 3M Company v. EnvisioWare, Inc., Case 09-1594-ADM-FLN, US District Court, District of Minnesota [REF. 5], the term “substantially simultaneous” was given the construction: “substantially overlapping durations”. This however still does not clarify the descriptor “substantially” in the use with the term “simultaneous” since in the most literal of uses, the terms “simultaneous” or “substantially simultaneous” may lead to assumptions of extraordinarily high expectations of synchronization in time when used without clearly defined restrictions, and thus deserves explicit discussion of its use herein.

When used herein, the term “simultaneous” will be used with the implication of a high degree of time synchronization of a plurality of actions. Furthermore, it is not to be taken in the most strictest sense, such as to describe a set of instantaneous actions as measured with infinite precision, but rather a well-defined set of events that one may perceive as occurring so closely in time, with respect to one another, that to distinguish the difference between them would require the significant attention by a common individual or specialized equipment. Taking that description into account, the terms “simultaneous” and “simultaneous events” are used herein to more specifically describe that intended actions begin to occur on multiple devices within a length of time that spans no more than one half (½) second of one another in time as would be noticed by a witness observing the plurality of devices concurrently at the initiation time of the event. The time frame of one half (½) second is intended to be used as the target time frame in the primary embodiment, and can be adjusted to be less or more in further embodiments as described with more detail hereinafter.

The term “window of simultaneity” is used herein as the specified maximum length of the time that spans over the occurrence of simultaneous events, and is expressed in units of time, such as seconds, milliseconds or nanoseconds. Different embodiments of the present invention employ windows of simultaneity that are generally different from one another so it is convenient to designate the variable TWIN as the length in time of a particular window of simultaneity. So that when used herein, the designation TWIN is to be understood as meaning the maximum length of time defining the window of simultaneity for the plurality of actions being described as being simultaneous for any embodiment within the scope of the present invention. In summary, within the scope of the present invention, the term simultaneous refers to events occurring within a time frame referred to as a window of simultaneity which is defined as the length of time equal to and less than a designated value of TWIN which is in units of time such as seconds, milliseconds or nanoseconds. The primary embodiment of the present invention designates TWIN as one half (½) second, since that is a useful value that is easily reachable using this method and system, however values less than one tenth ( 1/10) of a second have been obtained by testing performed by the inventor.

Due to latency variability across networks the transmission times of data sent between a computer server and the plurality of participating devices will be likewise variable. In order to quantify this aspect, a reasonable and typically imperfect network is first assumed, then the use of statistically based confidence levels for each participant in the group, based on several data packet transit time measurements, is determined. In particular, the primary embodiment of the present method and system uses the margin of error at a level of confidence of 99 percent, that is, ME₉₉, which is a length of time and calculated using eqn. 4 in Section I.2.f, for each client. The set of values of ME₉₉ (one for each client) results in an estimated confidence level that 99 percent of the plurality of clients will achieve a window of simultaneity due to variance in the network latency, defined by the range −ME_{99MAX} to ME_{99MAX}, where ME_{99MAX} is the maximum value of the set of ME₉₉ values gathered from the plurality of clients. As described with more detail hereinafter, it is by the use of this metric that the present method and system employs a quantified verification that the defined window of simultaneity, TWIN, can be achieved by the plurality of clients with a 99 percent level of confidence.

The designation of the value of TWIN for the primary embodiment of one half (½) second was determined to be easily reachable using data from timing experiments performed by the inventor and from published information of the round trip timing of data packets across the United States and the rest of the world [REF. 6, 7, & 8]. The minimum value of the window of simultaneity of an individual device is determined by the variance of the network latency of that particular device. That is, the minimum value of TWIN that could be assigned to the set of participating devices would be determined by the longest variance of latency in the set.

For exceptionally good network conditions, further embodiments maintain values of TWIN that are shorter than one tenth ( 1/10) of a second with 99 percent confidence levels. Moreover, further embodiments of the present method and system define longer values of TWIN, such as for uses that do not require such a high precision of simultaneity. In the future, as networks and the internal electronic timing mechanisms of devices become more accurate with better technologies, the present invention leads to simultaneous actions occurring within significantly smaller values of TWIN than that used in the primary embodiment disclosed presently.

### I.4.b Absolute Time and Relative Time

When used herein, the term “absolute time” is to be understood as a specific instant in time based on the commonly used time of day based on 24 hours and with an included specific day defined by an agreed upon calendar such as the Gregorian calendar. An example of an absolute time is that represented by the Universal Time Clock (UTC) on a given day, such as 12:12 pm, US Mountain Standard Time, Dec. 12, 2012.

The term “relative time” when used herein, is to be understood as a span of time defined by a specific length of time such as the number of hours, minutes, seconds or milliseconds (ms). In this use, a relative time can be calculated from the difference between two absolute times such as 12:12 pm, US Mountain Standard Time, Dec. 12, 2012 and 12:42 pm, US Mountain Standard Time, Dec. 12, 2012, which would be a relative time of 30 minutes or 1800000 ms.

### I.4.c Activity, Event, Event Initiation Time and Pre-event Time

When used herein, the term “activity” is to be understood as an action performed by an electronic device which is brought about by computer instruction originating either from software stored on the device or from instructions hard wired onto or formed into a microchip that is part of the device.

When used herein, the term “event” describes any specific happening associated with an activity or several activities that is caused to occur on an electronic device. Associated with each event is an “event initiation time” or simply “initiation time” which is a predetermined specific moment when the event is to begin. Further embodiments of the present invention utilize a single event and others utilize a series of events, as required for a particular use of the present invention. The primary embodiment of the present method and system uses an absolute time for the event initiation time, such as “3:27:17.21 pm EST” (27 minutes and 17.21 seconds after 3 pm, eastern standard time), while further embodiments utilize a relative time span for the event initiation time, such as 12 minutes and 16.8 seconds from now.

When used herein, the term “pre-event time” denotes the time period leading up to the event initiation time and is always designated in relative time.

### I.4.d Client and Client Group

When used herein, the term “client group” is to be understood as the plurality of electronic communication and computing devices that are to be participating in a simultaneous event. The term “client”, when used herein, is to be understood as one of the individual electronic devices that make up the client group. A client can have only one instance of participation in an event at one time, but a client may participate in more than one event for uses of the present invention that have several concurrent, on-going events. A client group can consist of two (2) or more clients.

The primary embodiment does not require the presence of human operators to complete the activity of the event, while other embodiments do require the presence of a human during the event to operate each client, such as to respond to a specific need according to the use of the invention. If an event requires human interaction to complete the activity associated with an event, then the presence of at least one human operator is assumed. Furthermore, each client within a client group may or may not be assigned the same activity as part of the event. The location of each client can be anywhere there is available network coverage, world-wide, using the particular communication technology associated to the client device, and that access to the network is available at an earlier time before the event initiation time as described in the sections hereinafter.

### I.4.e Task Server

When used herein, the term “task server” is to be understood as an electronic device utilized to take on the central function of coordinating the event, such as, but not limited to, a computer mainframe or programmable cell phone with network server capabilities. The main responsibility of the task server is to provide common time reference over the plurality of the client group so that the client group may use the task server based time to synchronize the event initiation. The task server must be able to be in network communication with each of the individual clients in the client group before a defined time previous to the initiation of the event as described with more detail below. The absolute timing of the event initiation is based on the time reference of the task server, and thus if a specific absolute time is required for the activity, then the task server is to be synchronized with accurate network timing such as commonly done by using an NTP server by those familiar with the art of computer networking.

In the primary embodiment, the task server is a single networked computer mainframe, and has the single role of supplying the information to each client device that is required for the time synchronization of the client group. As described with more detail hereinafter, the task server replies back to the client with this information when that same client sends a request. Moreover, the primary embodiment of the present method and system uses an absolute time for the event initiation time, such as “6:07:57.05 pm PST” (7 minutes and 57.05 seconds after 6 pm, Pacific Standard Time), so the task server is synchronized with a NTP server, as mentioned above. This is a contrast from further embodiments that keeps the event initiation time as relative, such as 35 hours, 12 minutes, and 32.45 seconds from a given point in time, or the need for extremely accurate absolute times, in which case the direct synchronization with an atomic clock server is used, providing for better than millisecond accuracies.

### I.4.f Timing Request Data Packets

When used herein, “timing request data packet” or more simply “timing request” are to be understood as a data packet, as described in section I.2.e, that contains all the information required by the task server to interpret that request as one to cause it to respond back to the same client device that sends the request. In order to minimize the risk of data packet segmentation, timing requests sent to the server by a device and the corresponding replies from the server to the device will be as small as possible for all embodiments.

In the primary embodiment, the body of the timing request data packet contains a single value of information, the text string “Client Timing Request.” Although further embodiments have more information such as, but not limited to an encrypted passcode for security and special client identification data, the object of the present invention can be achieved with very little information being passed by the client to the task server. Moreover, even the network address of the originating client is commonly not needed to be included in the data packet body since that is automatically included in the standard header of the packet when using commonly used protocol such as TC/IP, as known by those familiar with the art of network protocols.

The response data packet sent by the task server contains all the required information to reach the client and provide that client with timing data as described hereinafter. Similarly to the timing request sent by the clients, the body of the response data packet from the task server may contain various data depending on the embodiment.

I.5 Hardware

Hardware required for the present method and system consists of an electronic device capable of being the task server, at least two participating clients, and a network that connects the task server and plurality of clients. The network can be, but is not limited to the internet (World Wide Web), wide area network (WAN) or a local area network (LAN) as known by those of ordinary skill in the art of electronic communication. The connections and nodes that make up the network are to be that which are already in place or can be constructed using common network components such as, but not limited to wired or wireless computer servers, smart phones, earth bound or satellite based digital switches, cell tower antennas and routers.

Task servers and participating client devices must have networking capabilities to the extent that they can be connected to the network and electronically communicate between one other. Connections between a client and the task server are only required when information is to be transferred between them. As will become clear in the details hereinafter, the amount of time that the network connection is required is relatively small over the duration of the present method and system.

To achieve the objective of the present method and system, clients do not communicate between one another, just to the task server. Each client and task server are controlled by preinstalled software with an algorithm that causes them to perform the required process steps of the present method and system. Hardware for data storage is required for each client device and task server that is suitable to hold and administer the software requirements, such as but not limited to, commonly used volatile or flash memory and magnetic disk based hard drives, as is understood by those familiar in the arts of computer hardware and programming. Additionally, further embodiments require the task server to maintain records and other types of data depending on the specific use of the present invention. In these cases a more complex data storage method may be required such as software that is associated with a database as understood by those skilled in the art of computer storage and databases.

A client device can be either an electronic mobile communication or computing device with the ability to store software that causes it to send a request and receive event data through a network connection to the task server. Client devices include, but are not limited to, mobile communication devices such as handheld cellular or smart-phones, tablets, lap-top computers or satellite based communication devices, or non-mobile devices such as desktop computers and work stations.

As mentioned above in Section I.2.b, older hardware used for client devices can cause a slow reaction to the event initiation. As with any system construction, appropriate materials must be chosen to maintain robustness of the objective, and those familiar with the art of computer hardware and programming appreciate the measures that can be taken to alleviate the slowness or to simply exclude the device from participation subject to the precision requirements of a particular embodiment. It is the experience of the inventor that most programmable, network connectable devices manufactured after 2008 have the ability to react in time scales that are faster than typical minimum latency variances under the best conditions on wireless networks. It is for these reasons that the present method and system recommends the use of the most contemporary hardware and software for the client devices. However, as can be appreciated by those skilled in the art of computer hardware, any type of device discussed herein as being appropriate for a client device can be used after it has been vetted for the precision requirements of the particular embodiment being used.

The task server can either be a networked computer server or another network connectable device included above as a client, as long as it is i) recognized as the task server by the plurality of the client group, ii) can receive requests from the client group, iii) can transmit data to requesting clients, and iii) can be reached through a network by each client at a defined time before the event initiation time as described in more detail hereinafter.

The number of clients is not limited, but as described in the details and in a further embodiment hereinafter, the number of task servers will be determined by the ability of the task server hardware to efficiently coordinate with the plurality of participating clients. The details of the present invention provide the means to estimate if additional task servers are required, and is presented hereinafter.

I.6 Software

Before an event can take place, software with specialized algorithms must be installed on the task server and on each client. As described hereinafter, various embodiments of the present method and system require certain types of information that pertain to specific event activities and timing of the event to be stored on the task server along with software that causes it to accept client requests and subsequently send data to the requesting clients. The software on each client is such that it causes the client to send requests to the task server and subsequently receive, store and interpret the data from the task server, and then initiate the event at the proper time. As a further embodiment, there are uses of the present invention when certain input data is required to be recorded or sent to the task server as part of the event activity. In such cases the software on both the client and the task server are assumed to have the appropriate commands to perform the needed operations, as understood by those skilled in the art of computer programming.

I.7 Related Prior Art

Several previous inventions share similar objectives and methods to the present method and system. In this section those aspects are contrasted with those contained in the present invention so as to distinguish the present method and system from the prior art. The presented contrasting aspects are not meant to imply that these are the only such possible contrasts or that this limits the number of aspects or the number of possible similar prior art in any way.

U.S. Pat. No. 7,805,151 B2 by Feeney, et al., describes a system to create substantially simultaneous alerts on networked devices using a server. The objective of the Feeney disclosure is similar to that of the present invention, but uses different means and achieves a less precise window of simultaneity. The major differences between the present invention and that of Feeney include the precision of simultaneity and the confidence of the result. The present invention employs specific techniques to achieve quantified, high standards for both of these aspects as part of the objective, while the method of Feeney produces more lenient windows of simultaneity without attention to quantification. In particular, the method of the present invention produces appreciably strict and shorter (in time) windows of simultaneity than that of Feeney, and the present invention defines a level of statistically based certainty for which Feeney does not address. These differences in particular, along with the various other specific method dissimilarities, result in the present invention to be more applicable for uses that require a substantially higher degree of simultaneity than that of Feeney.

U.S. Pat. No. 5,923,902, by Inagaki, describes an invention that produces a concurrent output that is created by delaying data on faster nodes to match that on slower nodes so that the final output is concurrent. An important difference between the present invention and that of Inagaki is that the present invention gathers statistics of the network time lag and uses this information to accurately synchronize many clients (nodes) to a single clock located on a server, while the method of Inagaki measures the network lag and then actively delays data to match the slowest transmission.

U.S. Pat. No. 7,069,245 by Messick, et al., describes an invention that produces a near simultaneous delivery of information over a network having means to verify receipt of a transmission. In the disclosure by Messick, the event initiation time on the client device, which defines the time to display information, is the moment that a key is received at that client device. In the present invention, the moment of event initiation on each device is determined by a countdown to a common time in the future, during which there are periodic time synchronizations with a common source, referred to as the task server in the scope of the present invention. In the disclosure by Messick, the key arrives at the plurality of clients after being transmitted from a central server to begin the event activity. As stated in the disclosure by Messick, 7: 9-19, the broadcasting of the key may take several seconds and the transmission of the keys to the plurality of receivers may take several seconds, or one (1) to five (5) seconds total (in the United States), as stated by Messick. This is due to the finite output rate of a server and the transmission latencies of the various routes the key data must traverse. The primary objective of the present invention is to eliminate the effects of the network latency and time lags from server broadcasting bandwidth limitations so as to create a much shorter window of simultaneity, in particular windows that are less than one-half (½) second over the plurality of clients located anywhere there is an available network, world-wide.

### II BRIEF DESCRIPTION OF THE INVENTION

Disclosed herein are the methods and systems for the simultaneous initiation of events over a plurality of participating devices over a network such that the events begin at a predetermined instant in time, within a precisely defined time window relative to the plurality of devices. Furthermore, the present invention provides a means to determine a level of confidence, for which the defined window of simultaneity can be achieved, based on the statistical nature of data packet transmission over potentially vast, latency limited networks. That is, the present method and system provides that, at a given predetermined instant in time designated as t₀, a witness able to observe all the devices concurrently would note that the plurality of devices, would individually begin an activity within a time window of length designated as TWIN, and this time window will begin sometime before t₀, and end sometime after t₀. Moreover, the window of simultaneity will occur such that on average it is centered about the instant in time t₀. The time t₀ is a predetermined instant of time in the future, and has no limiting maximum value in the future, however there are limitations of how soon t₀ can be, as described in the detailed description of the invention hereinafter.

As a clearer illustration of the outcome of the present method and system, an exemplary embodiment is described here that defines the length of the window of simultaneity, TWIN, to be one half (½) second, utilizes 100 cell phones and a single task server. The event activity of this embodiment is to simultaneously begin playing a song at the same specified absolute moment in time, t₀, as determined on the task server clock using the method and system of the present invention. In this example t₀ is designated to be exactly 7:00 pm, as maintained by the task server clock. If the plurality of cell phones were located in a single room at the initiation time t₀, a person in that room would observe that all 100 cell phones would begin playing that song within a common time span of one half (½) second. That is, no more than one half (½) second would pass after the first phone started to play the song to when the last phone started to play the song, and the remaining 98 cell phones would have started in between those two times. During the time that spans the window of simultaneity, the absolute time clock on the task server will pass through t₀, that is 7:00 pm. The window of simultaneity will not necessarily straddle the initiation time, t₀, evenly, but it will contain the initiation time during the span of time TWIN. That is, relative to the task server clock, the first cell phone that initiates may do so as soon as TWIN before t₀. Thus, the first cell phone will begin no sooner than 6:59:59.50 and no later than 7:00:00.00 such that the time span, TWIN, will always incorporate t₀, that is 7:00 pm for this example. Due to the statistical nature of the network latency variance, this same event, if attempted many times, would result on average, in TWIN evenly straddling t₀. That is, from t₀−(TWIN/2) to t₀+(TWIN/2), which is from the absolute time 6:59:59.75 to 7:00:00.25 as maintained on the network server for the current example. Additionally, due to the same statistics used to determine the margin of error, the value of TWIN is to be taken as a maximum value, that is it should be understood as the maximum time span that the plurality of the client devices will initiate within. Due to this, it is possible that all the participating devices will initiate within a time span much shorter than TWIN.

This method and system also provides a statistics based confidence level to verify, before the activity is to take place, that the plurality of client devices will initiate within the time spanning the window of simultaneity. For example, an event is predetermined to begin exactly 17 hours, 15 minutes and 45 seconds from now (17:15:45.00 from now), and TWIN is set equal to one-half (½) second with the requirement that a confidence level of 99 percent be achieved for all participating clients. That is, all clients are required to be able to initiate the event within the time span of one half (½) second with a confidence level of 99 percent. In the context of this example, this means that 99 out of 100 attempts, clients that pass this criteria would begin the activity within the time span starting at 17:15:44.75 and ending at 17:15:45.25 from now, on average. To determine which clients cannot meet this standard, the present method and system requires each participating client device to record several timing measurements using timing requests to the task server at some time before the initiation time. Each client then uses that data, that the same acquired, to calculate the margin of error, ME_{CL}, for a designated level of confidence CL, as described with detail in Section I.2.f., where CL is equal to 99 for the current example. In this manner, each client determines the specific value of ME_{CL} that pertains to itself. The units of ME_{CL} are of time, such that value of ME_{CL} is one half the possible window of simultaneity for the given confidence level, CL, as limited by the network latency variance. In this manner it is known prior to the event initiation time t₀, which clients would not be able to initiate the event within the window of simultaneity at the defined level of confidence, based on the variance of the network latency. Continuing with the current example, since TWIN is designated as one half (½) second, clients would need a value of ME₉₉ to be less than TWIN/2 or one forth (¼) second if this were to be the metric for which a client's participation was based.

It is important to note that, within the scope of the present invention, the designated time, t₀, for the event, is not linked to the internally kept, absolute clock time that may be maintained by the device as would be an internally programmed alarm, but rather by a remote task server used to coordinate the event. Furthermore, the present invention requires that the timing kept by the client devices, as needed for the processes of the present invention, are relative times, that is, the differences between two moments in time, and kept as integral numbers of time units no larger than milliseconds, that is, increments that are no larger than 1/1000^{th} of a second.

The various aspects, features and advantages of the present disclosure will become more fully apparent to those having ordinary skill in the art upon careful consideration of the hereinafter Detailed Description thereof with the accompanying drawings described below. The drawings may have been simplified for clarity and are not necessarily drawn to scale.

### III BRIEF DESCRIPTION OF THE DRAWINGS AND TABLES

The primary embodiment of the present invention is described herein with the reference to the drawings in which:

FIG. 1 is a diagram showing the components in which the primary embodiment can be employed.

FIG. 2 is a flow chart showing the general process steps in accordance with the primary embodiment.

FIG. 3 is a diagram showing the time line of the process steps depicted in FIG. 2, in accordance with the primary embodiment.

FIG. 4 is a flow chart showing the steps as processed on the task server in the primary embodiment.

FIG. 5 is a flow chart showing the steps as processed on each of the clients in the primary embodiment.

TABLE 1 lists some values of critical t scores for several levels of confidence for numbers of samples up to 10.

TABLE 2 lists transit time data and resulting statistics from three clients during an example latency discovery process.

TABLE 3 lists the initial parameters for an exemplary embodiment. TABLE 4 is the resulting values of NP and TS for various T0I based on parameters listed in TABLE 3.

### IV DETAILED DESCRIPTION OF THE INVENTION

Various aspects of the disclosure are described more fully hereinafter with reference to the accompanying drawings. This disclosure may however be embodied in many different forms, and should not be construed as limited to any specific structure or function presented throughout this disclosure. Rather these aspects are provided so that this disclosure will be thorough and complete and will fully convey the scope of the disclosure to those skilled in the art. Based on the teachings herein, one skilled in the art should appreciate that the scope of the disclosure is intended to cover any aspect of the disclosure disclosed herein whether implemented independently of or combined with any other aspect of the disclosure. For example an apparatus may be implemented or a method may be practiced using any number of the aspects set forth herein. In addition the scope of the disclosure is intended to cover such an apparatus or method which is practiced using other structure functionality or structure and functionality in addition to or other than the various aspects of the disclosure set forth herein.

The word “exemplary” is used herein to mean serving as an example instance or illustration. Any aspect described herein as exemplary is not necessarily to be construed as preferred or advantageous over other aspects. Since relative time, that is the difference between two instantaneous points in time, is used extensively throughout the present method and system, the symbol Δt is used herein as a convenient way to designate a change in time or a time span. For example a Δt equal to 12.0 seconds is the time span between the two absolute times 11:45:20.0 PM EST and 11:45:32.0 PM EST.

Although particular aspects are described herein, many variations and permutations of these aspects fall within the scope of the disclosure. Although some benefits and advantages of the preferred aspects are mentioned, the scope of the disclosure is not intended to be limited to particular benefits uses or objectives. Rather, aspects of the disclosure are intended to be broadly applicable to different wireless as well as wired technologies, system configurations, networks and transmission protocols, some of which are illustrated by way of example in the figures and in the following description of the preferred aspects. The detailed description and drawings are merely illustrative of the disclosure rather than limiting the scope of the disclosure being defined by the examples and equivalents thereof.

The descriptions in sections IV.1, IV.2 and IV.3 illustrate the primary embodiment in terms of the overall process of the present invention. Descriptions that provide step-by-step details to accomplish the process by means of a flow chart are presented for the task server and client devices in sections IV.4 and IV.5, respectively.

### IV.1 Overview

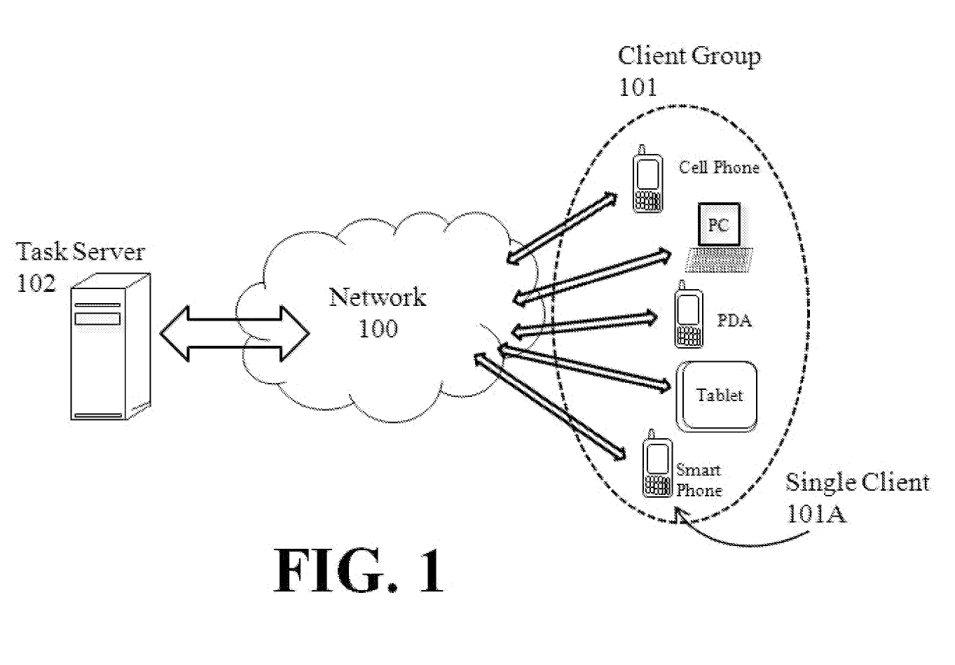

This primary embodiment utilizes a client group and single task server which has the capability to easily accommodate the network transmission rate needed for the objective of the present method and system. Referring to FIG. 1, the client group 101 consists of the participating devices for which the simultaneous event will take place. The task server 102 is the device that coordinates the event timing among the plurality of the client group 101 by the use of transmissions over the network 100. More particularly, the event initiation time is that relative to the timing kept by the task server 102, and the client devices that make up the client group 101, are periodically synchronized with the task server 102 to maintain accuracy among the client group 101.

When synchronizing to an event initiation, relative times are utilized, and the values of time transmitted between each client in the client group 101 and the task server 102 are to be integers representing the number of milliseconds (ms) in the primary embodiment, where one ms is equal to 1/1000^{th} of a second, or 0.001 second. The use of integers allows for smaller data packets that allow for network transmission with minimal latency, while the units of ms provides enough precision to achieve less than a one half (½) second window of simultaneity, designated as TWIN, as defined in Section I.4.a. When describing the primary embodiment, the value of one half (½) second will be used for TWIN as an easily realizable objective of this method and system. TWIN is designated as the maximum length of time defining the window of simultaneity based on the statistics of the network latency variance. That is, the plurality of client devices 101 will initiate within a time span that is less than TWIN.

The number of clients in the client group 101 is only limited by the capabilities of the device (or devices) used to be the task server 102 (or task servers), as is described hereinafter in more detail. The primary embodiment employs 1000 clients and a single task server. Also, the primary embodiment requires that the event initiation time is stored on the task server, and the instructional data needed to carry out the activity is to be stored on each client. A simple exemplary activity is chosen for the primary embodiment, which is the command to show the message “It's Show Time!” on the screen of each client device.

The method for which the timing accuracy on the task server 102 is maintained is dependent on the activity and use of the present method and system, such as whether the time is represented as a relative or absolute time, both of which are routinely implemented by those skilled in the art of network server maintenance. For example, if the event initiation time is to be specified as an absolute time with respect to Greenwich Mean Time with high accuracy, then the task server 102 may be synchronized with one of the various atomic clocks available over the internet. If it is represented as a relative time, such as “15 minutes and 23.5 seconds from now”, then the task server 102 would require a local countdown based on a time in the past, and there would be no need to synchronize the server with network time. Neither method is favored in the present invention as both produce the desired result of the timing being based on a single central server. In embodiments that require more than one task server, one of the task severs is required to be the main timing server for which the rest must synchronize. The primary embodiment of this invention uses the absolute time of “11:15:27.0 PM EST on Dec. 12, 2012”, that is 15 minutes and 27 seconds after 11 PM Eastern Standard Time on the 12^{th} day of December in the year 2012, for the event initiation time.

There are many permutations of how the required data is used to achieve the objective of the present invention, however the primary embodiment as described in this and subsequent sections below is sufficient to illustrate the required operational steps to achieve the objective.

### IV.2 Main Components

Referring again to the drawings, FIG. 1 provides a diagram of the basic components for which the primary embodiment is based on. The system includes the client group 101 and the task server 102 that transmit data between one another over the network 100. The client group 101 consists of devices that are to be initiated simultaneously, and can consist of any type of programmable, networkable device such as smart phones, personal computers, programmable cell phones, and computer tablets. For illustration purposes, and clarity, a single client representing any one of the plurality of clients, has been designated as 101A to be used as an exemplary device to describe the processes of the present method and system. It is to be understood that client 101A is indistinguishable in operation from the remaining clients in the client group 101 with respect to the software that controls the processes pertaining to the present invention. The network 100 connecting the client group 101 and the task server 102 is of the type that is required to each specific device used, such as, but not limited to wireless or wired, GSM, satellite link, TC/IP or a combination thereof as understood by those familiar with the art of electronic network communications. It is noted that a network connection between a client 101A and the task server 102 is only required to exist when that particular client 101A is sending or receiving data from the task server 102.

### IV.3 Generalized Process

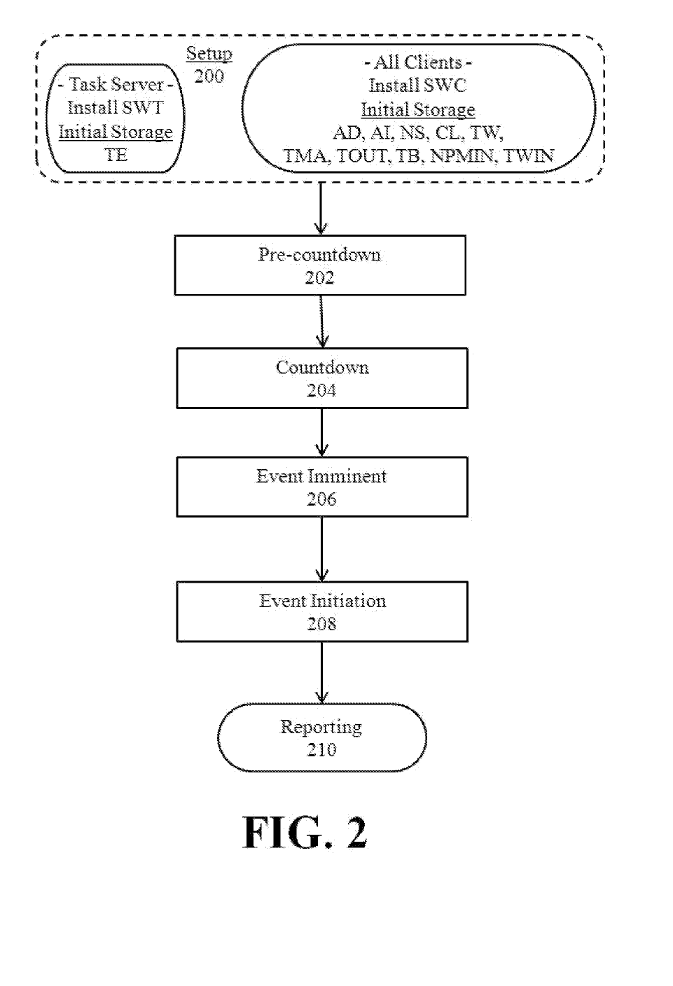

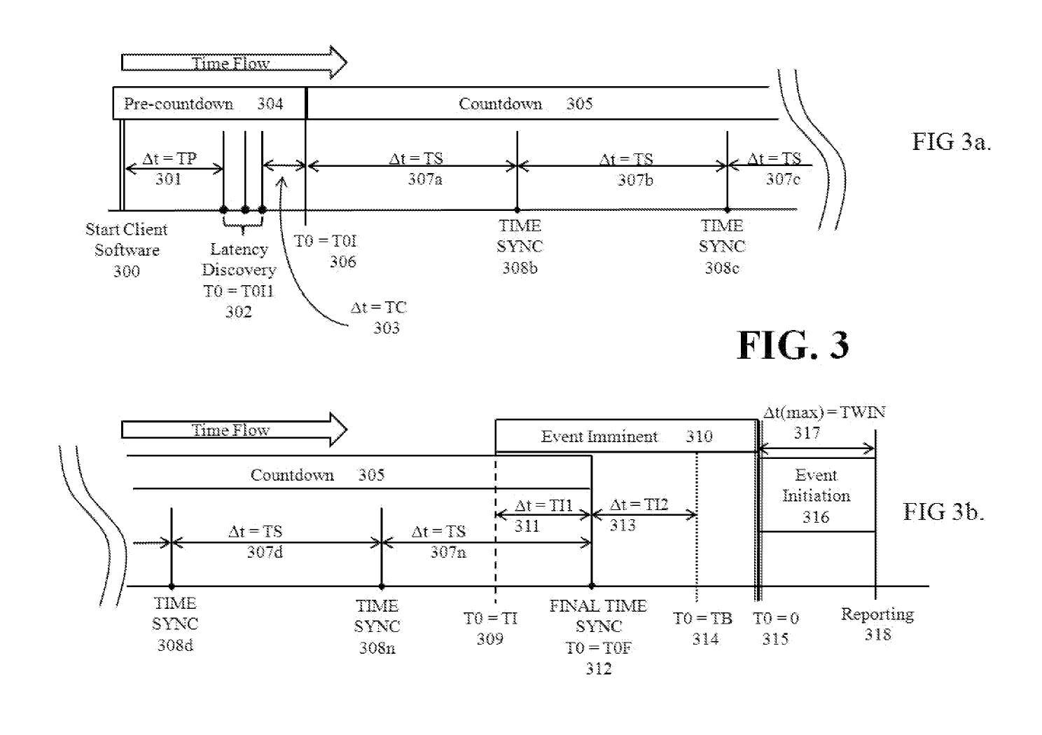

Referring now also to FIGS. 2 and 3, which provide a flow chart of the complete process and the corresponding timeline of the primary embodiment, respectively. FIG. 3 is divided into two parts, FIG. 3a and FIG. 3b, which divides FIG. 3 at an inconsequential point within the Countdown stage 305. FIG. 3a and FIG. 3b are to be considered as part of the same continuous, and complete timeline referred to as FIG. 3. FIG. 3 is intended to represent the timeline for each client device, more particularly FIG. 3 is an illustrative view of how the process of the present method and system chronologically organizes the steps taken by each client device from the time the software is started 300 to the Event Initiation 316, and then finally the activity of Reporting 318. The Reporting step 318, is not a requirement for all embodiments of the present method and system, but it is employed in the primary embodiment to demonstrate a final closing action of the overall process. Another important aspect of the timeline is that the length of time for which the Event Initiation 316 spans is less than or equal to the value of TWIN, that is the window of simultaneity 317.

When used herein, the designation “TO” is to be understood as the relative length of time until the start of the event, that is, the length of time until the start of the Event Initiation 316, which occurs at the point T0=0, 315 along the timeline. Furthermore, when referring to the timeline, FIG. 3, the value of T0, which is shown along the bottom at several points 306, 309, 312, 314, and 315, decreases to T0=0, 315, which is the precise moment the event is to begin. In this manner, the relative time until event initiation is represented by the constantly changing value of T0 along the timeline of FIG. 3. The value of T0 thus progresses as a countdown in FIG. 3 from left to right, starting at the point when the software on the client device is started 300, proceeds to the Event Initiation 208 & 316, which begins at the point in time when T0=0, 315, and finally ending with a Reporting step 318.

The Countdown stage 305 is divided into several sections representing a time period of Δt=TS. The number of sections is undetermined until the software on the client device is started, and the diagram illustrates this by designating each of these periods in succession as 307a, 307b, 307c, 307d and 307n, such that 307n is the last one of an undetermined number. Consequently, there is also an undetermined number of moments between each period for task server synchronizations designated 308b to 308n. As will become more clear in the details and definitions hereinafter, the value of the timing designation TS, which is used to systematically divide the Countdown step 305, depends on the starting time of the client software relative to the absolute time of the event initiation. The value of TS, which leads to the number of Countdown sections 307a to 307n determine the value of TI 309, which is the length of time allowed for the Event Imminent stage 310. Thus, although each client device will proceed through the same timeline steps before reaching the final simultaneous time point T0=0, 315, each will have a unique Countdown step 305 progression as determined by the time spans of TS, except by extremely rare coincidence. An additional aspect adding to the uniqueness of the timeline progressions for each client device 101A is that the value of the time span Δt=TP 301, is generated randomly creating a unique time span of the Pre-countdown step 304. The reasons for the unique progressions among the client devices 101, and thus the formula that determine the progressions detailed hereinafter, are to stay within the time periods such that the local timing mechanism is accurate for each device 101A while sending only a minimal number of timing requests to the task server 102.

The objective of the present method and system is accomplished using four primary stages: Setup 200, Pre-countdown 202 & 304, Countdown 204 & 305 and Event Imminent 206 & 310. The progression through these stages lead to the final two steps of the process which are the Event Initiation step 208 & 316 and the Reporting step 210 & 318. The four stages, and the steps that comprise them, are described individually hereinafter.

### IV.3.a Setup

During the Setup stage 200 the software appropriate to control the task server is installed onto the task server. Also, the software appropriate to control a client is installed onto the plurality of clients 101. The software for the task server and each of the client devices are designated as “SWT” and “SWC”, respectively, herein.

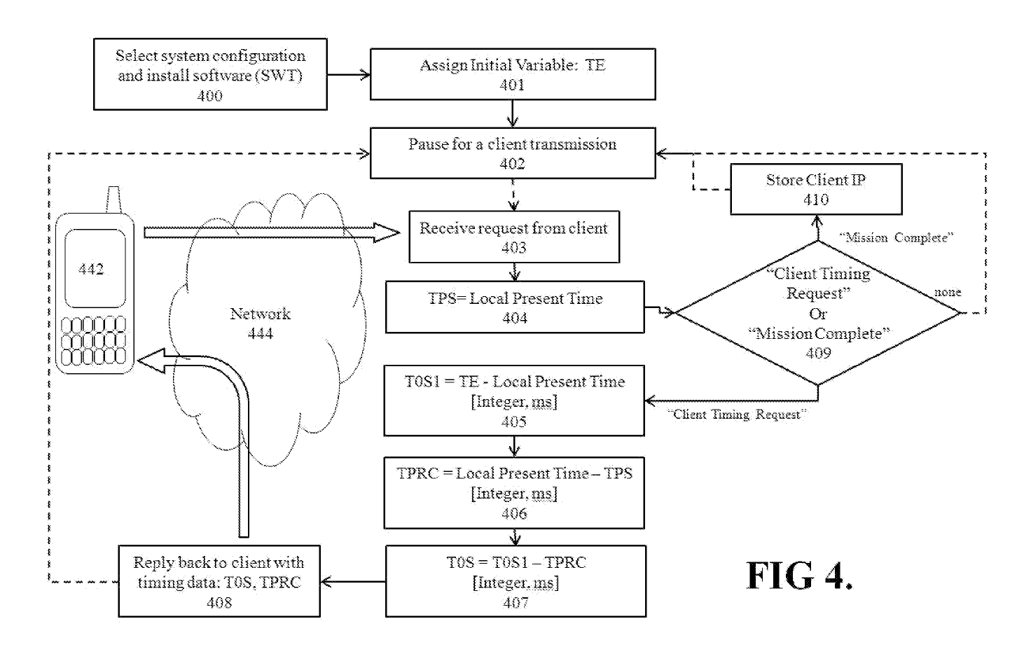

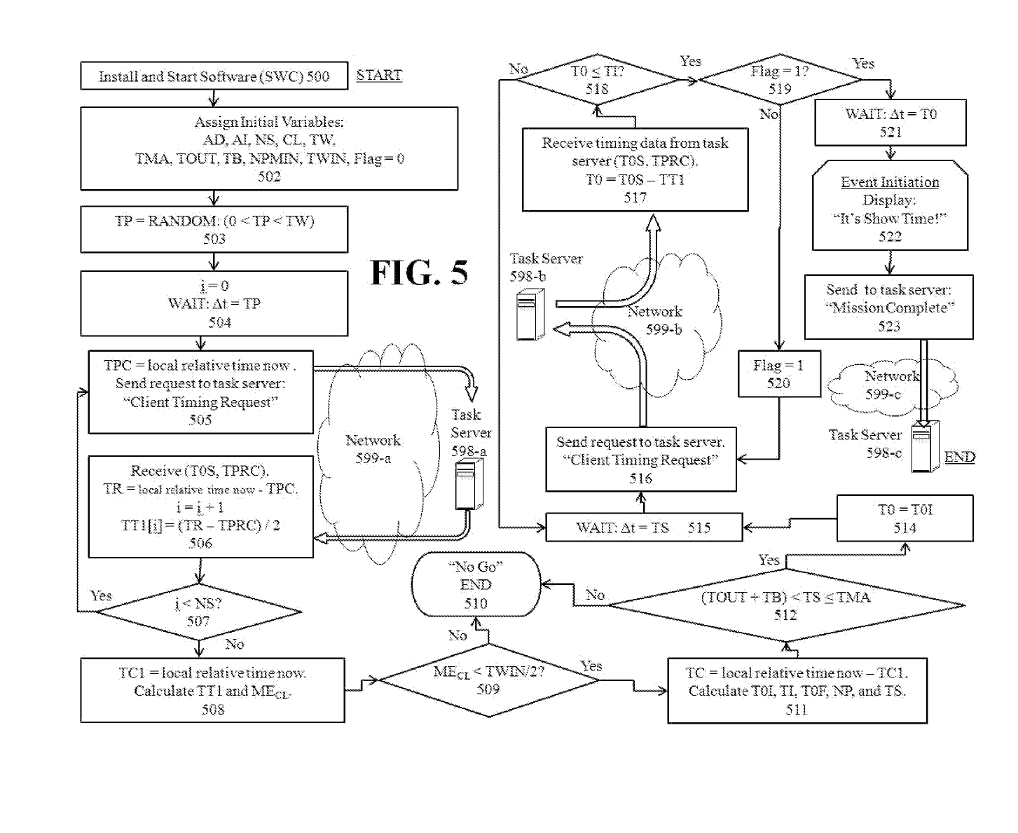

Herein, unless specified otherwise, specific actions taken by task server 102 and clients 101 are to be understood as commands that were implemented using the software SWT and SWC respectively. The flow charts that represent the algorithms as prescribed by the software SWT and SWC are shown below in FIG. 4 and FIG. 5, and are described with detail in Sections IV.4 and IV.5, respectively.

TE: When used herein, the designation “TE” is to be understood to represent the data indicating the event initiation time. In the primary embodiment TE is the only event information that is installed onto the task server 102, and it is the predetermined absolute time that the event is to be initiated simultaneously by each client in the client group 101. The example value for TE used in this embodiment is: “11:15:27.0 PM Eastern Standard Time Zone, USA on Dec. 12, 2012.” Other embodiments that have TE stored as a relative time, may for example use a defined time span like “12 days, 17 minutes, and 32.6 seconds” from midnight Coordinated Universal Time, Jan. 1, 1970.

The information set containing the ten values designated as AD, AI, NS, CL, TW, TMA, TOUT, TB, NPMIN and TWIN, and defined hereinafter, is stored onto each client in the client group 101 in the primary embodiment of the present invention.

AD: When used herein, the designation “AD” is to be understood to represent the data which identifies the network address of the task server. AD can be in several forms as known by those familiar with the art of computer networking, for example “www.mytaskserver01.net” or “789.456.123.” This is needed when a client connects with the task server 102 over the network 100, and thus is predetermined before the SWC is started in the primary embodiment.

Further embodiments utilize more than one task server, such as in the case where it is not predetermined how many clients will be included in the plurality of the client group 101 until later in the timeline process, such as after SWC has been started on one or more participating clients. In such embodiments AD may be changed during the process by the task server at the original address AD, once the final number of clients has been determined. This is described hereinafter with more detail in Section V-Further Embodiments.

AI: When used herein, the designation “AI” is to be understood to represent the data which contains the activity information. AI contains all the information that is needed for a client 101A to perform the activity at the event initiation time. For the primary embodiment the information used for AI is that needed to command each client device, as interpreted by SWC, to show the message “It's Show Time!” on the screen.

Further embodiments include events for which the clients in the client group 101 are not assigned the same activity or have an activity that requires other information, or is not defined until after the client software, SWC, is installed onto the particular client. In such embodiments, each client requests activity data from the task server at a convenient time in the timeline process. This is described with more detail in Section V-Further Embodiments.

TW: When used herein, the designation “TW” is to be understood to represent the startup wait period. One of the first tasks in the Pre-countdown stage 202 & 304 is the initial contact between the task server 102 and the client 101A, for the Latency Discovery step 302, described hereinafter. TW defines the short time period, after the onset of SWC, for which the initial transmissions from the clients 101 to the task server 102 will be spread in time relative to each other, making sure the task server 102 is not overly burdened at the beginning of the process. As is known by those skilled in the art, the ability for the task server 102 to respond to concurrent network transmissions is dependent on the hardware used, and the value of TW is defined based on that ability and the number of participating clients in the group 101. A task server built with commonly used hardware can handle many requests per second and thus a practical value of TW is calculated by dividing the number of participating clients by the number of requests per second the task server can nominally process. For example if a task server can expectedly handle 100 requests per second, then a 1000 member client group should have an assigned TW of 1000/(100 per second)=10 seconds. This is the value used for TW in the primary embodiment.
NS: When used herein, the designation “NS” is understood to represent the number of samples that are to be collected to perform the statistics of the data packet transit time variance used to determine the margin of error ME_{CL}. As described hereinafter, during the Latency Discovery step 302, a client 101A sends timing requests to the task server 102 to collect data to verify that the client 101A is expected to achieve the window of simultaneity as defined by TWIN. The number of such requests is the value of NS, and when used in the calculations during the Latency Discovery step 302, NS takes on the same role as the variable designated as N, that is the number of samples as described in Section I.2.f. The reliability of the statistical formulation of Section I.2.f increases with the value of NS, but it provides reasonable estimates for sample numbers less than ten as understood by those familiar in the art. In the primary embodiment of the present method and system the value of NS is designated as five (5) as a reasonable value to achieve the desired correctness while maintaining a minimal number of timing requests to the task server 102.
CL: When used herein, the designation “CL” is to be understood to represent the level of confidence for the margin of error, ME_{CL}, for each client when verifying that the network latency variance is small enough for a client 101A to initiate the event within the window of simultaneity. The value of CL is represented by a percentage of complete confidence ranging from zero (0) percent (no confidence) to 100 percent (highest possible confidence) as described in Section I.2.f. Moreover, the value of CL defines how strict the present method and system performs the objective of simultaneous event initiation among a group of clients, and varies depending on the timing precision requirement of the specific use of the embodiment. More particularly, CL is the level of confidence that the network latency will not vary by more than ME_{CL} for the client 101A. ME_{CL} is calculated with a level of confidence, designated as CL, and it must be verified that ME_{CL} is less than TWIN/2, so that if 12:02:32 pm is the absolute time the event is to be initiated, for example, then client 101A will, on average, initiate the event within the range defined by 12:02:32 pm—TWIN/2 and 12:02:32 pm+TWIN/2 with a level of confidence equal to CL. For the primary embodiment, the value of CL is 99 percent and thus the value of ME₉₉, the margin of error with a level of confidence of 99% is used, as described in Section I.2.f.
TMA: When used herein, the designation “TMA” is to be understood to represent the maximum time for the minimum required accuracy of the internal timing mechanism of the client device 101A. More particularly, TMA is the length of time for which the client device 101A can maintain an accuracy of several seconds with respect to a highly accurate time source such as an atomic clock, as described in the Section I.2.b. The value of TMA is used in calculations performed in the Pre-countdown stage 202 & 304, in particularly to determine the value of TS. The value of TMA is not strict, and is chosen such that the timing accuracy of the client device 101A, while in the Countdown stage 204 & 305, maintains an accuracy of three (3) seconds or better, to the actual event initiation, during the long term countdown. That is, when the value of T0 is still larger than several times that of the value of TS, during which time a high degree of accuracy is not required. As will become evident using definitions and the process details hereinafter, the countdown accuracy becomes more important as the value T0 becomes less than that of TS.

The value of TMA is typically different for each device, and is stored with the specific appropriate value on each client device. However, for all client devices used in the primary embodiment, the electronic timing mechanisms built into the devices are assumed to maintain an accuracy of three (3) seconds or less with respect to a highly accurate source over a three (3) hour period, and thus the value chosen for TMA is three (3) hours (10800 seconds or 10800000 ms). This is a reasonable and conservative assumption for most computers and smart phones, as known by those skilled in the art. Also, the value of three (3) seconds is not critical for the object of the present invention, and can be chosen shorter or longer, however if chosen too long the corresponding TMA value may be so long that the accuracy condition is not valid since over long periods of time device timing mechanisms can measurably vary as described in Section I.2.b. If chosen too short, then the number of timing requests to the task server 102 may become too burdensome, as will become more evident in the details hereinafter. An accuracy condition of approximately three (3) seconds, with a corresponding TMA value of three (3) hours is chosen for all participating clients in the primary embodiment as a reasonable value to maintain a dependable accuracy during the Countdown stage 204 & 305. Although the same value for TMA is chosen for all clients for simplicity in the description of the primary embodiment, it is also a reasonable choice that covers most contemporary electronic timing mechanisms as understood by those familiar in the art.

TOUT: When used herein, the designation “TOUT” is to be understood to represent the network timeout period. That is, TOUT is the maximum length of time that the client 101A will be allowed to wait for the task server 102 to reply back after the client 101A has contacted it using a timing request. Typically this should not be more than ten (10) seconds. In the primary embodiment, this value is assigned as five (5) seconds on all participating clients, which is a commonly used value in network communication and reasonable length of time as understood by those familiar with the art.
TB: When used herein, the designation “TB” is to be understood to represent the value of the timing buffer. More particularly, TB is a short time period along the timeline depicted in FIG. 3, at T0=TB 314, within the Event Imminent stage 206 & 310 and before the Event Initiation 316 when T0=0, 315. This time period is used for a final safety time gap before the Event Initiation 208 & 316 begins, and can be used to perform a pre-initiation activity such as a “Get Ready” message or a warning sound for the client users, for example. The choice of the length of this time period ranges from zero (0) seconds to as long as TW. In the primary embodiment the value of TB is assigned seven (7) seconds for all participating clients 101 as a reasonable example value.
NPMIN: When used herein, the designation “NPMIN” is to be understood to represent the minimum number of synchronization periods. During the Countdown stage 204 & 305, the client 101A periodically transmits timing requests to the task server 102 as described with more detail hereinafter. NPMIN is the fewest number of requests the client 101A will make during that stage. NPMIN must be greater than zero. Since the length of time between each request is limited by TMA, as described in more detail hereinafter, the actual number of periods during the Countdown stage 204 & 305 will be generally greater than NPMIN, but not less. In the primary embodiment the value of NPMIN is assigned five (5) for all participating clients 101.

The Setup stage 200 is complete once all the values are stored onto the clients 101 and the task server 102. Once the software, SWC, on the client 101A has been started that client proceeds into the Pre-countdown stage 202 & 304, as controlled by SWC. In the primary embodiment human interaction is required to start SWC on each of the participating clients, however further embodiments may not require human interaction, such as when an internal alarm is set within the device to start the software SWC.

The software, SWC, on the plurality of participating clients does not need to be started simultaneously on the individual clients, but a condition for starting SWC on each client is that it is to be started so that at least the minimum number of synchronization periods, NPMIN, can be performed before the event initiation time. This condition is explicitly defined in terms of a length of time, and will become more apparent within the details disclosed hereinafter.

From the point in time after which the software SWC has been started on at least one of the clients, the task server 102 is, in effect, waiting for the clients 101 to individually send timing requests. As understood by those familiar in the art, network server software operating on the task server 102 causes it to passively wait while listening for network transmissions. An instance of the software, SWT, on the task server 102 is run by the operating system controlling the task server 102 each time a transmission from a client 101 arrives from the network.

There is no human interaction required to produce the objective of the primary embodiment once SWC has been started on the plurality of participating client devices 101, and the task server 102 has SWT installed and is functioning, by means of its own operating system as a network server. The flow charts describing, in detail, the algorithms of SWT and SWC are detailed in Sections IV.4 and IV.5 respectively, following the continuation of the process descriptions below.

### IV.3.b Pre-countdown

During the Pre-countdown stage 202 & 304, the client 101A first calculates the value for TP, pauses for the length of time represented by the value of TP 301, and then performs a Latency Discovery step 302. The values of TC 303, T0I 306, TI 309, NP, and TS 307, are also determined during this stage for use in the ensuing stages, which are the Countdown stage 204 & 305 and the Event Imminent stage 206 & 310. The values that result from these steps will be unique to each participating client. These assignments and associated calculations are described hereinafter.

TP: When used herein, the designation “TP” is to be understood to represent the initial pausing time period for the client 101A. More particularly, TP is a randomly generated integer number between 0 and TW that represents the number of milliseconds (ms) to pause 301 before continuing to the Latency Discovery step 302. The value of TP is a random integer assigned on each client by SWC using a randomization seed that depends on when SWC is started, and using a time resolution of ms or smaller. Randomization routines are common computational algorithms based on an initial seed value, as known by those skilled in the art. Since each client is working independently, the value of TP will be generally different for each client. As described hereinafter, the Latency Discovery step 302 requires that several timing requests are sent to the task server 102, thus by pausing a length of time defined by TP, each client begins the Latency Discovery step 302 at different times spread over the predefined window TW, minimizing the burden on the task server 102 at the onset of this stage in the event that many or all of the clients 101 start SWC at nearly the same moment. In the primary embodiment, the length of time of 7257 ms (7.257 seconds) is assigned to the client device 101A within the group 101 as an example value of TP, a value that could have been randomly determined by that client device. It is to be noted that the remaining participating clients have a different value of TP, but are not discussed herein, as the presented description will now follow along the details of one of the clients 101A, without diminishing the completeness of the present disclosure.

Immediately after the time period Δt=TP 301 expires, the Latency Discovery step 302 begins. This step is used to determine the network latency variance and associated statistics of the data transmissions between the task server 102 and the client 101A. The results of the Latency Discovery step 302 are based on the statistical relations described in Section I.2.f.

During the Latency Discovery step 302, the client 101A sends several timing requests to the task server 102 to gather data which is to be used to compute the mean one-way time of transit, TT1, and the standard deviation of the transit time samples, Sₘ, between that client 101A and the task server 102 as described in Section I.2.f. The number of such requests is designated by the value of NS.

The data packet sent from the client device 101A to the task server 102 contains all the information required for the software, SWT, on the task server 102, to interpret that a client 101A has sent a timing request. In the primary embodiment, the body of the timing request data packet contains a single value of information, the text string “Client Timing Request.” Although further embodiments have more information such as, but not limited to a passcode for security and special client identification data, the object of the present invention can be achieved with very little information being passed by the client 101A to the task server 102. Moreover, the network address of the originating client 101A is not needed to be included in the data packet body since that information is automatically included in the standard header of the packet when employing commonly used network protocols, as known by those familiar with the art of network communication. As discussed in Section I.2.e, the data packets sent between the client 101A and the task server 102 should be kept to small so that segmenting of the data packet, while in transmission, is avoided.

The data sent back from the task server 102 are two integer numbers representing lengths of time in units of milliseconds (ms) or smaller, and are assigned as the values of “T0S” and “TPRC”, respectively as described hereinafter. The primary embodiment of the present method and system uses the units of milliseconds.

T0S: When used herein, the designation “T0S” is to be understood to represent the relative time until the initiation of the event with respect to the absolute time as represented by the clock on the task server 102.
TPRC: When used herein, the designation “TPRC” is to be understood to represent the relative time that has elapsed on the task server 102, as measured on the task server 102, starting from the moment when the timing request is first received from the client 101A and ending when the requested timing data packet is sent back to the client 101A.

During each request of the Latency Discovery step 302, the client 101A counts how many milliseconds in time, pass until the reply returns from the task server 102, and assigns this value to a variable designated herein as TR. The one way transit time for each request, designated as the i^{th} request, TT1[i], is calculated by subtracting TPRC from TR and dividing by two (2):

TT1[i]=(TR−TPRC)/2 (eqn. 5)

TT1: When used herein, the designation “TT1” is to be understood to represent the mean one way transit time of a data packet between the client 101A and the task server 102. That is, TT1 is the mean of the set of values: TT1[i].

The Latency Discovery 302, requires a minimum of three (3) requests to achieve reasonable statistics when calculating the value of the margin of error, ME_{CL}, as described in Section I.2.f. For the primary embodiment, five (5) requests are used, that is NS is equal to five (5), so that five (5) separate values of TT1[i] are acquired, one from each of the separate requests to the task server. The standard deviation of the sample, Sₘ, the mean one-way transit time, TT1, and the margin of error at a confidence level of 99 percent, that is ME₉₉, are then calculated using the plurality of TT1 [i] values acquired from the five (5) timing requests, TT1[1], TT1[2], TT1[3], TT1[4], and TT1[5]. This is done by using eqns. 1-4 and TABLE 1, as described in the Section, 1.2.f with the value of N=NS=5. The value of T0S, received from the last request from the task server 102, is momentarily stored to be used in an ensuing step that determines an accurate value of the current event initiation time T0.

As an example of the interpretation and use of the data gathered in the Latency Discovery step 302, TABLE 2 shows possible results from three (3) timing requests from a client group consisting of three (3) clients, designated C1, C2 and C3. The value of ME_{CL} is used to verify, on an individual basis, that a client has a nominal network connection with a predictable data packet transmission latency to within a predefined level of confidence, CL. For illustration, the resulting values of ME_{CL} for levels of confidence of 99%, 98%, 95%, 90% and 80% are listed in TABLE 2.

Referring to the example values listed in TABLE 2, it is noted that even though some transit times are several hundreds of milliseconds, all the values of ME_{CL}, which describe the predictability of the variability, fall well within the 250 ms requirement, that is, one half (½) of TWIN for the primary embodiment, with a level of confidence of 99 percent. Thus, this data predicts, with the high confidence level of 99 percent, that all three clients will initiate the event within the defined window of simultaneity, which is TWIN=½ second=500 ms, for the primary embodiment. Additionally as expected, Table 2 shows that for confidence levels less than 99 percent, the clients may perform within windows of simultaneity that are trending even shorter in time.

Continuing to refer to TABLE 2, Client C1 can expect the data packet transit time from the task server to be within the range of TT1±ME₉₉=(53±55) ms. As will become more clear in the details hereinafter, a value of ME_{CL} that is larger than TT1 is not problematic since the value of TT1 is only used to determine a more accurate countdown to the event initiation, while the value of ME_{CL} solely represents the expected maximum length of time, on average, before or after the exact event initiation time, with respect to the task server timing, that the client will initiate the event with the level of confidence defined by the value of CL. Thus, Client C1 would, on average, expect to achieve the event initiation within the window of 55 ms before to 55 ms after the actual initiation time, and is expected to perform within this window 99 times out of 100 attempts. Although Client C3 has the slowest mean transit time of 524 ms and larger than TWIN/2, this is not of concern, since the value of ME₉₉ is the significant factor, and with 45 ms it is the best of the three clients, and would be expected to perform well within the primary embodiment restriction of ±250 ms, to be simultaneous with respect to the task server timing.

TABLE 2
Example Margin of Errors for Three Clients.

| | Client C1* | Client C2* | Client C3* |
|---|---|---|---|
| Timing Request | 52 | 120 | 521 |
| 1 - TT1 [1]: | | | |
| Timing Request | 44 | 136 | 532 |
| 2 - TT1 [2]: | | | |
| Timing Request | 63 | 115 | 517 |
| 3 - TT1 [3]: | | | |
| Mean One Way | 53 | 124 | 524 |
| Transit Time (TT1): | | | |
| Standard Deviation (Sₘ): | 5.508 | 6.333 | 4.485 |
| Margin of Error with | 55 | 63 | 45 |
| 99% Confidence (ME₉₉): | | | |
| Margin of Error with | 39 | 45 | 32 |
| 98% Confidence (ME₉₈): | | | |
| Margin of Error with | 24 | 28 | 20 |
| 95% Confidence (ME₉₅): | | | |
| Margin of Error with | 17 | 19 | 14 |
| 90% Confidence (ME₉₀): | | | |
| Margin of Error with | 11 | 12 | 9 |
| 80% Confidence (ME₈₀): | | | |

*All numbers are in units of milliseconds(ms).

It is important to inspect the value of the margin of error, ME₉₉, to verify that each client connection has the predictability to initiate the event within the predetermined value of TWIN. That is, to verify that the value of ME₉₉ is less than or equal to one half (½) the value of TWIN. If the value of ME₉₉ is found to be excessively large for a client, then a decision must be made to determine the outcome of the process for that particular client. Depending on the specific use of the present invention, several choices are available in further embodiments for this situation. These include to halt the participation of this particular client, perform an additional Latency Discovery step 302 for additional data points to verify accuracy, or to continue on to the next step with a warning to re-do a similar Latency Discovery step during the course of the Countdown stage 204 & 305, until there is no time left before the Event Imminent stage 206 & 310, and then re-evaluate the client's transmission variability metric ME₉₉. The latter choice is possible since high accuracy is not required until the final timing synchronization 312 is performed in the Countdown stage 204 & 305, at which time the Event Imminent stag 310 has already begun. In the primary embodiment, the choice is to simply halt the participation of the client if this situation occurs during the Pre-countdown stage 202 & 304, and allow the process to continue for all clients that have values of ME₉₉ that fall within half the value of TWIN.

In the event that the network conditions are so poor that several clients do not qualify, then further embodiments include a predetermined number of clients that are required to proceed with the event initiation. In the primary embodiment, one or more clients are required to qualify to continue the process.

T0I1: When used herein the designation “T0I1” is to be understood to represent the initial relative length of time until the Event Initiation 208 & 316 is to begin, starting from the moment immediately after the Latency Discovery step 302. T0I1 is represented as an integral number of milliseconds, in the primary embodiment, and is determined by subtracting the value of TT1 from T0S. Each client utilizes the time synchronization data, T0S, received from the last request of the Latency Discovery step 302, and the previously calculated one way transit time, TT1, to calculate the value of T0I1:

T0I1=T0S−TT1. (eqn.6)

T0I: When used herein, “T0I” is to be understood as the initial relative length of time until the Event Initiation 208 & 316 is to begin, starting from the moment immediately after the completion of the calculations that determine the length of time of the ensuing stages leading up to the Event initiation 208 & 316. The point on the timeline T0=T0I 306 is a corrected form of T0IL, defines the moment that the Countdown stage 204 & 305 begins and, as will become clear in the details hereinafter, can only be determined after other values have been calculated. As is all local timing values on the participating client devices, T0I is represented as an integral number of milliseconds, in the primary embodiment.
T0F: When used herein, the designation “T0F” is to be understood to represent the length of time until the Event Initiation 208 & 316 immediately after the final time synchronization between the client 101A and the task server 102. Moreover, the value of T0 along the process timeline shown in FIG. 3 is defined as T0F 312, and will be generally different for each client.
TI: When used herein, the designation “TI” is to be understood to represent the length of time of the Event Imminent stage 206 & 310. At T0=TI 309 the timeline enters into the Event Imminent stage 206 & 310. During this stage the final timing synchronization is made to the task server, and T0 is set equal to T0F 312. The length of time that TI represents must be greater than that of T0F.

The Event Imminent stage 206 & 310 is the last stage until the moment of Event Initiation 208 & 316. The time difference from T0=TI to when T0=T0F is defined as the intermediate variable TI1 311, and the time difference from T0=T0F to T0=TB is defined as the intermediate variable TI2 313. The final time period within the Event Imminent stage 310 is from T0=TB 314 to T0=0 315. These assignments cause the following relations to be valid:

TI=TI1+TI2+TB (eqn. 7)

T0F=TI2+TB (eqn. 8)

TB is a known value, and the values of TI1 and TI2 must be chosen. There is no unique solution to eqns. 7 and 8, but there are constraints on TI and T0F. At T0=T0F 312 there will be no more timing requests made to the task server, therefore the length of time assigned to T0F must be less than TMA:

T0F<TMA. (eqn. 9)

Also, TI must be greater than T0F, and T0F must be greater than TB, as illustrated in the timeline of FIG. 3:

TB<T0F<TI. (eqn. 10)

The values of TI1 and TI2 can be chosen arbitrarily with the restrictions that they fit within the time span of the Event Imminent stage 310, while allowing for the time buffer TB 314, to be valid. In the primary embodiment of the present method and system, TI1 and TI2 are set to the known values of TP, and TW−TP+TOUT, respectively:

TI1=TP, (eqn. 11)

TI2=TW−TP+TOUT. (eqn. 12)

Defining TI1 and TI2 this way also defines their sum, TI1+TI2, as the startup wait period, TW, plus the network timeout period, TOUT, both known quantities. Using equations 7, 8, 11, and 12 the values of TI and T0F are then given in terms of known values:

TI=TW+TOUT+TB, (eqn. 13)

T0F=TW+TOUT+TB−TP=TI−TP (eqn. 14)

The possible values of TI and T0F satisfy the relations given by eqns. 9 and 10 as required.
TC: When used herein the designation “TC” is to be understood to represent the length of time for the client device to perform the calculations to determine the values of ME₉₉, TT1, T0IL, TI and T0F. That is, up to the point when T0F is calculated using eqn. 14. In particular, TC represents the approximate length of time to perform the calculations between the last received reply from the task server in the Latency Discovery step 302 and the start of the Countdown Stage 305. The length of time represented by TC is used to increase the accuracy of the timeline point T0=T0I 306.

The value of TC is only approximate because to be most accurate it should incorporate the time it takes to perform all the calculations to the end of the Pre-countdown stage 202 & 304, however, the last calculation is that for TS, which relies on the value of T0I, which in turn is based on the value of TC, but also requires time to calculate as will become evident in the description hereinafter. Thus the additional length of time it takes to perform the calculations beyond T0F will not be included in TC. This error however is small since the remaining calculations are few and simple from this point on, and should not be equal to more than one (1) using typical hardware found on common electronic computing devices. Thus, the imparted error is much smaller than even the most shortest realistic values of TWIN, and thus not consequential to the objective of the present invention.

Although the value of TC will normally be only several milliseconds, and thus will not significantly influence a long Countdown stage 204 & 305, there are embodiments for which the Latency Discovery step 302 is performed very near in time to the beginning of the Event Initiation 315, at which time the value of TC will become more important. Thus it is because of consistency that the variable

TC is determined at each point a value of ME₉₉ and TT 1 are calculated, in particular when a further embodiment utilizes multiple Latency Discovery steps during the process leading up to the Event Initiation 208 & 316, as may be done during the Countdown stage 204 & 305.
T0I is now calculated subtracting the value of TC from the value of TOI1:

T0I=T0I1−TC (eqn. 15)

NP: When used herein, the designation “NP” is to be understood to represent the number of countdown periods illustrated as 307a to 307n within the Countdown stage 204 & 305. Since the value of NP is initially undetermined, and must be determined by several constraints, as described hereinafter, the time period 307n is to be understood as the last period of the set of periods that span the Countdown stage 305. Consequently, there is also an undetermined number of moments between each period for task server synchronizations, as described hereinafter, designated 308b to 308n.
TS: When used herein, the designation “TS” is to be understood to represent the length of time of each countdown period 307a to 307n within the Countdown stage 204 & 305, the plurality of which form the complete Countdown stage 204 & 305. More particularly, TS is defined as the length of time between synchronization requests that the client 101A sends to the task server 102 at points along the timeline of FIG. 3, shown as 308b to 308 n, and 312. In the primary embodiment of the present method and system, the value of TS for each time period 307a to 307n will be the same, but as will become more clear in the details hereinafter, that value can only be determined after other values have been calculated.

Each client will need to perform time synchronizations with the task server during the Countdown stage 305. This occurs at the points labeled 308b to 308n, and finally at T0=T0F 312. The number of times this is required, NP, depends on T0I and TMA. Also NP is constrained to be greater than or equal to NPMIN, that is, NP≧NPMIN. To determine NP, the relation equating TMA with the number of periods that are only required to fit into the Countdown stage 305 is inferred from FIG. 3. If the value of NP0 is defined as the integral number that fits exactly within the Countdown stage 305 if the length of time of the period, TS, is exactly equal to TMA, then equation 16 is true:

TMA×NP0=T0I−T0F (eqn. 16)

Solving for NP0 gives the more useful form:

NP0=(T0I−T0F)/TMA,rounded up to the nearest integer. (eqn. 17)

If NP0 is greater than or equal to NPMIN then NP is set to the value of NP0, otherwise NP is set equal to the value of NPMIN, that is:

For NP0<NPMIN:

NP=NPMIN, (eqn. 18)

For NP0≧NPMIN:

NP=NP0. (eqn. 19)

Since the value of T0I and TC are known at this step in the process NP is also now determined using equations 17 through 19.

The value of TS is calculated such that it is long enough to minimize the number of task server requests, and short enough so that the client device 101A is accurate to within several seconds of the Event Initiation time 315, with respect to the task server 102, while in the Countdown stage 208 & 305. That is, a restriction to the maximum value of TS is such that TS is not longer than TMA, or TS≦TMA. Additionally, the value of TS needs to be greater than the network timeout period, TOUT, plus the timing buffer, TB to keep the periods from overlapping in the case of short TS periods 307a to 307n and a slow responding task server 102. These constraints on are mathematically written as:

(TOUT+TB)<TS≦TMA (eqn. 20)

TS is deduced in the same manner as in eqn. 16, but now with the actual number of periods that will be used, that is NP, in place of NP0, and TS in place of TMA, and then solved for TS, which results in:

TS=(T0I−T0F)/NP. (eqn. 21)

TS is less than or equal to TMA since NP0 was originally determined using TMA in eqn. 17. Since NPMIN can be chosen arbitrarily high in further embodiments, the value of TS may lie outside the constraint that TS>(TOUT+TB). This situation can occur when the software is started too close, in time, to the time of the event initiation, or when NPMIN is chosen too high since the higher the value of NP, the shorter the time period TS represents. If it is found that the value of TS is less than the sum of TOUT and TB, then in the primary embodiment, the process for the particular client cannot continue beyond this step.

Referring to TABLES 2 and 3 for an example set of solutions generated for an exemplary embodiment of the present method and system. TABLE 3 illustrates how the values of NP and TS can adjust to different values as T0I is changed from as long as 30 days to as short as 15 seconds for the parameter values listed in TABLE 2. It should be noted that the values of TS are not more than 10800000 ms (3 hours), which is that defined by TMA in the primary embodiment, and the number of countdown periods, NP, is appropriately valued to keep that from happening, as calculated from the above eqns. 18, 19, and 21. When the value of TS becomes physically impossible to maintain within the restriction defined by eqn. 20 then the result is shown with the words “No Go” in the table, meaning that the value of T0I is too short for the client to participate, that is, the client has started the software (SWC) too late to be able to participate. An additional indication that T0I is too soon for the client to participate is that NP is less than NPMIN as shown in TABLE 3 where T0I=15 seconds. However it is observed that using the condition of NP≧NPMIN as a check is not conclusive as is observed when comparing the outcomes in TABLE 3 where T0I=30 seconds and T0I=15 seconds.

TABLE 3
Initial parameters for an exemplary embodiment.

| | | |
|---|---|---|
| Number of Clients*: | 1000 | Units |
| TMA(Client)*: | 3 | Hours |
| Maximum Request | 100 | Requests Per Sec |
| Rate(Task Server)*: | | |
| TW: | 10000 | ms |
| TP**: | 7257 | ms |
| TOUT*: | 5 | Seconds |
| TB*: | 10 | Seconds |
| NPMIN*: | 5 | |
| TI: | 25000 | ms |
| T0F: | 17743 | ms |

*Initially known values at the time of Setup 200, FIG. 2.
**Random number between 0 and TW, determined by the Client software(SWC) at runtime.

TABLE 4
Resulting values of NP and TS for various
T0I based on parameters listed in TABLE 3.

| T0I* | | NP | TS [ms] |
|---|---|---|---|
| 30 | Days | 244 | 10622878 |
| 10 | Days | 84 | 10285503 |
| 5 | Days | 44 | 9817778 |
| 3 | Days | 28 | 9256509 |
| 1 | Days | 12 | 8639112 |
| 12 | Hours | 8 | 7198521 |
| 6 | Hours | 6 | 5397782 |
| 1 | Hours | 5 | 3597042 |
| 30 | Minutes | 5 | 716451 |
| 10 | Minutes | 5 | 356451 |
| 5 | Minutes | 5 | 116451 |
| 3 | Minutes | 5 | 56451 |
| 1 | Minutes | 5 | 32451 |
| 30 | Seconds | 5 | 8451(No Go) |
| 15 | Seconds | 3 | 2451(No Go) |

*T0I is based on a value of TE, an initially known value at the time of Setup 200, FIG. 2.

### IV.3.c Countdown

Once the value of TS has been calculated the Pre-countdown stage 202 & 304 ends and the Countdown stage 204 & 305 immediately begins. It is this moment that the relative time until Event Initiation 316, TO, is equal to T0I 306. Each point in FIG. 3 labeled as “TIME SYNC” 308b to 308n, represents the moment when the client 101A sends a single timing request to the task server 102 and uses the data that is sent back from the task server 102 to synchronize the current value of T0 to the length of time until the Event Initiation 316 with respect to the task server clock.

In the primary embodiment, the algorithm used by the task server 102 to compute and reply back to the client 101A at the time synchronization points 308b to 308n, and 312 is the same as that used during the Latency Discovery step 302. Furthermore, the timing requests sent at these points by the client 101A to the task server 102 are also the same as that sent during the Latency Discovery step 302, that is, a data packet containing the text string “Client Timing Request.” The task server returns the two values representing T0S and TPRC, and of these two values only the value of T0S is used here. The new value of T0 at each timing synchronization points 308b to 308n, and 312 is determined by subtracting the one way transit time, TT1, as determined from the Latency Discovery step 302, from T0S. That is:

T0=T0S−TT1. (eqn. 22)

It is in this manner that each client device is maintained in synchronization with the task server clock for extended amounts of time. The transmissions between the client and the task server is the same as that during the Latency Discovery step 302 with the intention to not only produce a simpler method by reusing a principal algorithm on the task server 102 and client 101A, but one that can also be easily extended into further embodiments as described hereinafter, in Section V—Further Embodiments.

During the countdown intervals Δt=TS 307a to 307n, the client 101A uses its own internal timing mechanism to count down in integer units of milliseconds or less from the most recent relative time retrieved from the task server 102. In doing so, the client 101A remains in time synchronization with the task server 102, and thus maintaining the synchronization for extended lengths of time, which may be longer than the client device 101A could preserve using the local timing mechanism on that device. Moreover, a network connection 100 between the task server 102 and the client device 101A is not needed during the time intervals Δt=TS 307a to 307n. It is in this manner that the participating clients 101 use the task server 102 to re-synchronize their internal countdown to even the most lengthy time periods before the Event Initiation 316. This is repeated NP times, at which point the new value of T0 is less than or equal to TI 309, and the timeline, FIG. 3, enters into the Event Imminent stage 310. The last task server time synchronization is then performed resulting in the final updated value of T0, designated as T0F 312.

### IV.3.d Event Imminent

The Event Imminent stage 206 & 310 serves as a type of timing warning track signaling the client 101 A will not begin another time counting interval of TS. Since the participating clients 101 have started the process at random times each client will arrive at this stage spread over the same window in time defined above as TW. Once this stage is entered the client 101A will perform one final time synchronization with the task server 102, T0=T0F 312, and proceed to countdown from T0=T0F in integer units of milliseconds or less until the moment of event initiation, T0=0 315, using its internal timing mechanism. The primary embodiment uses units of milliseconds, as it has throughout the present disclosure.

During this stage, T0=TB 314 will be passed at some point. In the primary embodiment, nothing is done at this point, and the countdown merely continues until T0=0 315. In further embodiments this is a point when the client device may perform last second preparations for a complicated activity or even show a countdown screen for the human operator to prepare something required for the activity associated with the event initiation.

### IV.3.e Event Initiation

The Event Initiation 208 & 316 commences as soon as the internal timing of the client device 101A reaches T0=0, 315. At this point in time the software causes the client device 101A to immediately perform the event activity. In the primary embodiment, the activity is to display on the screen the words: “It's Show Time!”

### IV.3.f Reporting

After the activity is complete the primary embodiment of the present method and system requires the plurality of clients 101 to report back 210 & 318 to the task server 102. In the primary embodiment the client 101A reports back to the task server 102 by transmitting a data packet that contains the text string “Mission Complete.” When the task server 102 receives the text string “Mission Complete” it stores the IP address of the client 101A, which is extracted directly from the data packet header, as is commonly done by those familiar with the art. The storage of the reported information may be any type of volatile or nonvolatile electronic or magnetic memory, as understood by those familiar with the art of computer data storage, as needed to complete the specific use of the present method and system. The method and system is complete when the task server 102 receives the text string from the plurality of clients 101.

### IV.4 Task Server Flow Chart

Referring now to FIGS. 1, 2, 3 and 4. The task server system configuration is selected so as to allow for network connections to client devices as is commonly performed by those skilled in the art. When used during the present description of the Task Server Flow Chart, it is to be understood that the referenced task server is the same as that referenced in the other sections, that is, the task server 102 as depicted in FIG. 1. Software designed for the task server, SWT, which employs the algorithm, to produce the actions, described in this section is installed onto the task server 400. As is commonly performed by those skilled in the art of network server operation, the internal clock and daily calendar of the task server is set to periodically synchronize with a common time and day server such as a Network Timing Protocol (NTP server. Similarly, a networked atomic clock could be employed in alternate embodiments of the present invention in order to achieve synchronization. In the primary embodiment the time that the event initiation is to occur, TE, is stored 401 on the task server as an absolute time in the future such as that represented by the Universal Time Clock (UTC) on a specific day represented by the Gregorian calendar. In the primary embodiment the value of TE is incorporated as part of the SWT software. This also completes the task server portion of the Setup stage 200.

In the primary embodiment of the present method and system, the task server now waits for transmissions 402 to begin arriving from a participating client 442 by means of the network 444. The client 442 in FIG. 4, is to be understood as a representation of an individual client among the plurality of clients 101 as depicted in FIG. 1. Moreover, the client 442 can be any client from the group of clients 101, and is illustrated in FIG. 4 with the purpose to describe the process flow for any individual client in the group 101. Furthermore, it is to be understood that a separate instance of the software SWT on the task server will be run concurrently as required as clients from the group 101 each transmit a timing request to the task server which may or may not be arriving concurrently over the time frame spanning this method and system. Logically this does not produce problems on the task server since there are methods to run individual instances of the same software as is commonly employed on network servers by those skilled in the art.

When a request arrives 403 the task server first sets a process timing variable, designated herein as TPS, to the present absolute internal time of the task server 102. This is done using a time resolution of a millisecond (ms) or less 404. In the primary embodiment, of the present method and system, the units of choice is ms. The message body is then checked for one of the two possible permissible text strings “Client Timing Request” or “Mission Complete” 409. If neither are detected then the algorithm reverts back to the waiting mode 402. If “Mission Complete” is detected then the IP of the incoming transmission is extracted and stored 410, then the algorithm reverts back to the waiting mode 402. If the text string is “Client Timing Request” then the next step taken is to calculate the length of time until the event initiation time, TE, in the resolution of ms. This is done by subtracting the absolute present internally kept time of the task server from TE, and storing that value into a variable, as an integer number of milliseconds, designated herein as T0S1, 405. The next step is to calculate the total processing time required for the operation before sending the reply to the client. This is done by subtracting TPS from the local present internally kept time of the task server, and storing that value into the previously defined variable TPRC, as an integer number of milliseconds 406. The final calculation for the task server in this embodiment is to subtract TPRC from T0S1 and store that result into a variable, as an integer number of milliseconds, designated as T0S, 407.

When performing mathematical functions on quantities represented as absolute times, such as the time of “Dec. 12, 2014 at 4:05:12.56 PM”, it is common to convert that time into a relative time first, such as to the number of milliseconds since a consistent time in the past. This can be done many different ways depending on the operating system of the task server, the programming language used, and other considerations as understood by those skilled in the art of computer programming.

The two resulting values of T0S and TPRC are then sent back 408 over the network 444 to the originally requesting client 442, and the algorithm reverts back to the waiting mode 402. T0S is the relative length of time until the event initiation is to take place, represented as an integer number of milliseconds, as attained just before the task server replies back to the requesting client, and TPRC is the length of processing time the task server used to complete the steps 404, 409, 405, and 406 as attained just before the task server replies back to the requesting client, and is also represented as an integer number of milliseconds.

This flow chart represents the primary embodiment of the present method and system and was chosen as the primary embodiment because it is of the simplest form or several other embodiments that can be used to achieve the objective of the present method and system. Further embodiments incorporate the use of higher time resolutions than milliseconds and check to verify that the variable values and calculated results are valid. An example of value checking is to verify that TE and T0S1 represent times that are in the future. Other checks may include security aspects, such as if a use of the present invention requires secure connections, or a form of coding of the data contained in the transmitted data packets, such as encryption, as understood by those skilled in the art of computer network security.

### IV.5 Client Flow Chart

Referring now to FIGS. 1, 2, 3, 4 and 5. It is to be understood that the client represented by the Client Flow Chart, that is FIG. 5, is any of the individual clients among the participating client group 101. Moreover, FIG. 5 is an illustrative description of the step-by-step procedure of each client as prescribed by the client software designated as SWC herein. Each client in the participating group 101 will have this same software, causing each client to follow the same process concurrently. Furthermore, FIG. 5 is a diagram illustrating the procedure that the client follows to achieve the timeline flow depicted in FIG. 3.

The term “local relative time now” when used herein, is to be understood as a relative time, that is, a span of time that is the difference between the absolute time at that particular instant and an absolute time in the past as determined on the timing mechanism on the client device. The value of local relative time now is represented as an integral number of milliseconds, as is used for relative times throughout the primary embodiment. The absolute time in the past used to determine the value of local relative time now is always the same, such as “12:00:00 midnight, Jan. 1, 1970, UTC.” The value of local relative time now is constantly changing to a higher value, and thus each time local relative time now is used, it is to be understood that the value has increased since the previous use.

The same physical network 100 and task server 102 are employed throughout the primary embodiment of the present method and system. Within the symbolic process illustrated by FIG. 5 there are several places where the client communicates with the task server. These communications occur at the three steps 505 & 506, 516 & 517, and 523. Accordingly, there are three corresponding depictions of the task server and network pairs labeled as 598-a & 599-a, 598-b & 599-b, and 598-c & 598-c, respectively. The lettering a, b and c are used to designate different steps in the process while utilizing the same network and task server. It is to be understood herein that each task server 598-a, 598-b, and 598-c listed in FIG. 5 represents the same physical task server, such as depicted as 102 in FIG. 1. Likewise, it is to be understood herein that network 599-a, 599-b, and 599-c listed in FIG. 5 represents the same physical network, such as depicted as 100 in FIG. 1. The three representations of the single task server and network are adopted in FIG. 5 with the intention to preserve the flow using steps that do not require crossed lines while maintaining minimal space.

Software designed for the client device, SWC, to produce the actions of the algorithm described in this section is installed onto each client device, and started 200 & 500. In the primary embodiment the values of AD, AI, NS, CL, TW, TMA, TOUT, TB, NPMIN and TWIN, as described above in Section IV.3, are part of the software installation package and are assigned to variables once the program has been started 502. Another variable designated herein as “Flag” is set to the initial value of zero (0).

Once the client software, SWC, has been started and assigned the required variables, the next task is to assign a random integer value to the variable TP that is between the values zero (0) and TW 503. This value represents the number of milliseconds to pause during the next step 504, after setting an incrementing variable, designated herein as i, to zero (0). The variable designated as i in the flow chart of FIG. 5, is the same as that used in eqn. 5 within the description of Section IV.3.b.

Immediately after pausing for the time length equal to the value of TP, the variable TPC is assigned the local relative time now and a timing request is sent 505 over the network 599-a to the task server 598-a. The information contained in the timing request for the primary embodiment is the text string: “Client Timing Request.” Referring to FIG. 4, this corresponds to the task server receiving the request 403. The two values of T0S and TPRC, each of which is an integer that represents a length of time in milliseconds, are sent back by the task server 408, and received back at the client 506. When the reply is received by the client 506 the value representing the difference between the local relative time now and TPC is calculated, maintaining the units of an integral number of milliseconds, and then assigned to the value of the variable TR. Additionally, the value of i is incremented by one (1) and the i^{th} value of TT1, that is TT1[i], is assigned the result from the operation of (TR−TPRC)/2, 506.

If the value of i is less than the value of NS 507 then the process loops back to 505 and repeats. It is this looped process, 505, 506 and 507, that gathers information for the Latency Discovery step 302 of FIG. 3. If the value of i is NS at 507, then TC1 is assigned the value of the local relative time now, and the values of the mean one way transit time and the margin of error with a level of confidence of CL, TT1 and ME_{CL}, are calculated and assigned 508 according to the details of Section IV.3.b. In the primary embodiment CL is 99 percent, and TWIN is one half (½) second, so that the maximum value that ME_{CL} (=ME₉₉) can be is TWIN/2, or 250 ms. If the value of ME_{CL} is greater than or equal to TWIN/2 509, then the software on the client ends due to poor network variability 510.

If the value of ME_{CL} is less than TWIN/2 509, then TC is assigned the value from the operation of the subtraction of TC1 from the local relative time now, and the values T0I, TI, T0F, NP and TS are calculated in accordance to Section IV.3.b 511. The condition that TS is greater than (TOUT+TB) and that TS less than or equal to TMA is then evaluated 512. If both of these two conditions are not met then the software on the client ends due to a lack of time until the event initiation is to occur 510. If these conditions 512 are true then the variable T0 is set to the value T0I 514 and the program pauses for the length of time TS 515. At this point the client has entered into the Countdown stage 204 & 305.

After pausing for the amount of time represented by the value of TS 515, the client then sends a timing request 516 to the task server 598-b over the network 599-b. As described above, this is the same physical task server and network as used at step 505. The body of the data packet sent by the client contains the text string: “Client Timing Request.” The task server 598-b receives 403 and processes the request, as detailed in Section IV.4 and FIG. 4, steps 403 to 407, and then sends a reply containing the values of T0S and TPRC over the network 408 & 598-b back to the originating client. The client receives the reply and assigns the value of the operation T0S−TT1 to the variable T0 517. The condition that T0 is less than or equal to TI is checked 518. It is during the steps 516-518, that one of the successive TIME SYNC steps is performed along the timeline of FIG. 3, designated as 308a to 308n. If the condition that T0 is less than or greater than TI 518 is negative then the software pauses the routine for the time length of TS 515, and proceeds again to the time synchronization steps 516-518, that is, another TIME SYNC step in the Countdown stage 305 of FIG. 3. It is in this loop that the client performs the long term count down 305, during which it resynchronizes with the task server timing after a pause of a length of time equal to TS, 307a to 307n, until the condition 518 can be answered in the positive.

When the condition 518 becomes positive then the Event Imminent stage 310 has been reached. If the variable Flag is still assigned the value zero (0), that is, the condition at 519 is negative, then the variable Flag is assigned the value one (1) 520, and a final time synchronization is performed 516-517. After this, the conditions at 518 and 519 will both be positive and the value of T0 is equal to T0F 312 by definition as described in Sections IV.3.c and IV.3.d. The client then pauses for the remaining length of time until T0 is equal to zero (0) 521. At the end of this pause 315 the event is initiated by immediately displaying the message “It's Show Time!” on the screen of the client device 208 & 316 & 522.

In the primary embodiment, after the activity is complete, that is, the message “It's Show Time!” is displayed, the client sends a final transmission over the network 599-c to the task server 598-c with the text string “Mission Complete” in the body of the data packet 523. As described above, this is the same physical task server and network as used at steps 505 and 516. This is the last action of the client device for the primary embodiment.

It is noted that the value of TPRC is not used beyond the Pre-countdown stage 202 & 304 in the primary embodiment. It is kept as part of the task server data reply package, however, for two reasons: 1) The algorithms are simplified for the task server and client devices without a choice to be made whether to include TPRC, and 2) further embodiments use the up-to-date value of TRPC to verify network integrity during the Countdown stage of the timeline 305, as a replacement of the TIME SYNC points 308 with additional Latency Discovery steps 302. Further embodiments are described hereinafter.

While the present invention has been described in its preferred embodiments, it is to be understood that the words which have been used are words of description rather than of limitation.

### V. FURTHER EMBODIMENTS

Although the permutations are numerous among many further embodiments that employ a more dynamic role of the variables and devices, the process of stages described in the primary embodiment of the present method and system is maintained to achieve the objective of the invention. That is, the concept of the five stages of the timeline are preserved: Setup 200, Pre-countdown 202 & 304, Countdown 204 & 305, Event Imminent 206 & 310 and Event Initiation 208 & 316. Additionally, the mathematically founded conditions for the timing synchronizations and constraints as determined by the equations listed as eqns. 1-22 are also preserved. However certain further embodiments modify the placement, in time, of some of the steps of the process, such as the Latency Discovery 302 and TIME SYNC 308a to 308n steps.

Using the description of the primary embodiment disclosed herein as the most basic and important exemplary embodiment, those skilled in the art of computer programming, networking and statistics will appreciate the modifications disclosed in this section to produce further embodiments of the present invention.

### V.1 Task Servers

### V.1.a Multiple Task Servers

According to a further embodiment of the present invention, more than a single task server is used. In particular, when the networking capabilities for a single task server are insufficient to efficiently handle the plurality of clients, more task servers are added. The need for multiple task servers can be specifically quantified by inspecting the value of TW, as described herein in Section IV.3.a as the waiting period for the client device at startup. Since the value of TW is determined by the ratio of the number of participating clients and the request rate of the task server, that is, the number of requests per second the task server can nominally process, an overburdened task server is indicated by an excessively high value of TW as understood by those familiar in the art. By placing a limit on TW, that is by specifying a maximum value that TW can have, an evaluation of the need to add more task servers is straightforwardly done.

Different devices have different network capabilities due to aspects such as hardware restrictions and network connectivity, and thus generally have unique values of TW associated with them. For embodiments using multiple task servers the value of TW is to be determined for each group of clients associated with a particular task server independently. That is, each task server will have associated with it a unique value of TW for the clients that it is to service, although as understood by those familiar in the art of computer servers, it is possible to construct network servers that have essentially the same capabilities using identical hardware.

When used herein, the designation “NCₘₐₓ” is understood to represent the maximum number of clients that a task server can administer during the process of the present method and system. For example, if a limit is placed on TW of one (1) minute, and the request rate of the task server is 100 per second, then the value of NCₘₐₓ is 100*60=6000 clients. Thus, if each task server has the same client handling capabilities of 100 per second, then this exemplary embodiment uses an additional task server for each instance the number of clients exceeds a multiple of 6000.

According to yet a further embodiment, when multiple task servers are used, and the total number of clients is not equal to the sum of the values of NCₘₐₓ for the plurality of task servers, then the client burden on the task servers is to be spread among the task servers such that the burden across the plurality of task servers is approximately equal. In particular, if each task server has the same maximum request rate, then the clients are to be spread as evenly as possible, and in cases where the task servers have different maximum request rates, the number of clients per task server should be accordingly weighted, that is, the plurality of clients would be spread such that the ratio of clients to NCₘₐₓ on each task server is the same, and is equal to the total number of clients divided by the sum of the values of NCₘₐₓ for the plurality of task servers. For example, suppose there are 1000 clients using three (3) task servers labeled ts_a, ts_b and ts_c with the following values of NCₘₐₓ: 300, 400, and 500, respectively. Then the ratio of 1000/(300+400+500)=⅚ is to be the ratio of clients to NCₘₐₓ on each server. That is, the number of clients being served by ts_a, ts_b and ts_c are 250, 334 and 416 respectively.

When using embodiments that utilize multiple task servers it is essential to maintain time synchronization among the plurality of task servers. This is done by having each task server synchronize to an NTP time server or to designate one of the task servers as the central time keeper for each of the other task servers to synchronize with, as is commonly done by those skilled in the art of network communications.

### V.1.b Clients in the Role of Task Servers

According to a further embodiment of the present invention, the task server role is performed by one or more of the participating clients. This requires a client device that has the ability to be a central server across the available network as described herein. Those familiar in the art of smart phone and computer tablet technology can appreciate that the current technology has such capabilities, although limited, and is expected to be more capable in the future. An example use of this embodiment would be in situations where a group of individuals, each with a smart phone device, wish to perform a synchronous activity when there is no network task server available over the network. For instance, the group has an available network among themselves, and they wish to race to a certain central location using a synchronized starting tone from their handheld devices. A single device in the group is chosen as the task server where the exact start time, TE as described herein, is manually input such that the rest of the group can then synchronize to that device which is performing as the task server of the present method and system. If the same device that is performing the role of the task server is also a participant in the activity then by using the flowcharts listed in FIGS. 4 & 5, one skilled in the art of computer programming will understand the basic modifications needed to produce this further embodiment.

### V.2 Passing Additional Information Sent Between the Client and the Task Server

According to a further embodiment of the present invention, data sent between the client and the task server contains additional information than that described in the primary embodiment. Depending on the use of the present method and system the additional information contains, but is not limited to, supplemental data for event activity revisions, record keeping, timing changes, client and task server identification and security. This allows for more complex activities and event initiation time schemes. In the primary embodiment there are several points in time when the client sends timing requests to the task server and subsequently receives replies from the task server. Further embodiments utilize these communications to add additional information to the data packets that are transferred. According to a further embodiment, for example, the task server reply data packet includes activity data with each time synchronization step 308 during the Countdown stage 204, 305 such that the client devices are maintained not only in time synchronization, but with some added information to modify the activity, such as the message to display, etc.

### V.2.a Dynamic Variables

In the primary embodiment the set of values such as those initially stored onto the client: AD, AI, NS, CL, TW, TMA, TOUT, TB, NPMIN and TWIN, and TE, which is stored onto the task server, are used as unchanged constants throughout the process that makes up the present method and system. According to further embodiments of the present invention, these values are used as dynamic variables, that is, the values change according to certain conditions over the course of the method and system.

As an illustration, suppose that multiple task servers are being used and one of them must be replaced, due to hardware issue for example, during the process of the disclosed method and system. In this further embodiment the client timing request results in a reply with the additional data that contains enough information so that the client software is instructed to use the new task server. For example, the timing request returns with the additional text string “AD:123.456.987,” instructing the client to replace the old value of AD, the task server address, with the new one in the text string. This further embodiment is particularly useful when the number of clients is allowed to change during the Countdown stage 204 & 305, and potentially increasing the number above NCₘₐₓ, and thus requiring a new task server to be added without having to restart the process for all clients.

According to a further embodiment of the present invention, the value of TWIN, that is the length of time of the window of simultaneity, is changed during the process of the present method and system from the original value. According to a yet further embodiment, Latency Discovery steps are also performed during the Countdown stage 305 of the method and system in place of the time synchronization steps 308b to 308n. The influence of the network latency variability is quantified for a specified level of confidence, CL, in the present method and system and designated as the margin of error ME_{CL}. If it is found that one or more clients have poor margin of errors, that is ME_{CL} is greater than TWIN/2, then TWIN may be modified such that it is the largest value of the client group. In such cases, a yet further embodiment also has a value designated as the largest allowable TWIN that can be accepted for continuation for which it must compare, or requires input from the users of the client group to accept the lower value of TWIN to continue.

According to a further embodiment of the present invention, the value of CL, the level of confidence of the margin of error, is treated as a variable. As with the primary embodiment, this further embodiment verifies the margin of error is small enough for the client group, that is, that ME_{CL} is less than TWIN/2. However, this further embodiment uses TABLE 1, or similarly tabulated or calculated data to determine the margin of error for several values of CL to make a decision of whether or not the event is to take place depending on the level of confidence for the plurality of the client group. For example, if the values of ME₈₀ for the plurality of clients is less than TWIN/2, but only 19 out of 40 clients have a value of ME₉₉ that is less than TWIN/2, then a more particular further embodiment will cancel the event initiation, while another particular further embodiment will accept a value of ME₈₀ as being sufficient for the particular use of the present method and system.

In the primary embodiment the value of Event Initiation Time, TE, is incorporated as part of the software installed on the task server. According to further embodiments the value of TE, or other values such that for AD, CL, TWIN, etc. are stored into other devices or media so that the task server may retrieve the values at any time, such as a local or remote database, and in yet further embodiments the value of TE, or other values such as that for AD, CL, TWIN, etc. are sent within a data packet from a remote device, possibly a client device. Since the task server software is passive, that is, it waits for requests before executing an instance of the software, SWT, it is up to a remote device to cause the task server to update variables that are local to the task server operation in the present method and system. An example is a particular further embodiment of the present invention that adds a software instruction to SWT that causes it to update information from a database immediately after a certain client from the group sends a timing request. If there is a change in one of the variable values, then that change can be passed along to the client group in turn, as they send in timing requests. In this manner variable values can be modified without starting the method and system over from the installation step, and thus providing a use of the present method and system that is highly complex.

It is to be understood that any or all of the designated values of the primary embodiment can be variable, as well as any added values that may complete a specific use of the present method and system. Although the present disclosure describes only a few values that are varied for further embodiments as examples, it is not to be implied that these are the only values for which variability applies.

### V.2.b Additional Task Server Requests

According to a further embodiment of the present invention, each client checks for new values in-between the time synchronizations steps 308b to 308n, which may be on the task server or another previously designated device reachable on the network that have additional information for the activity. In this further embodiment the client sends an information request to the task server immediately after a time synchronization step 308 using a data packet containing the text string that the software on the task server interprets as an information request, which is “InfoPlease.” Upon receiving such a request, the task server replies with any values that have changed since the last timing request such as the text string “AD:123.654.325 NUM:534” which changes the task server network address to 123.654.325 and updates the variable storing the current number of participating clients to 534. According to yet further embodiment, the client sends the data packet containing “InfoPlease” to an information server on the network that is not performing as the task server, to obtain needed information that may have changed since the last request.

### V.2.c Additional Latency Discovery Steps

The timing request and reply transmissions between the client and the task server during the Countdown Stage 305 in the primary embodiment is the same as that performed during one of the data point collections of the Latency Discovery step 302. This is done purposefully as the primary embodiment because it allows for the straightforward modification producing a further embodiment that performs a Latency Discovery step at each time synchronization step 308b to 308n. According to a further embodiment, the client device performs the Latency Discovery step more often, such as every time the TS period has expired during the Countdown stage 305, in place of the time synchronization steps 308b to 308n. This can result in higher accuracies when a network is not operating nominally, such that when the variability in the packet transmission time is high.

### V.2.d Security of Data

Other particular further embodiments produce the objective of this invention under high security by passing the information in a different form, such as being encoded such that only the task server and client will be able to decode it. A common example of this is the addition of an exchanged cypher key, as is commonly done by those skilled in secure networks and cryptography.

### V.3 Client Software Distribution

According to a further embodiment, client devices, that are to be added into the participating group, download the software, SWC, directly from the task server or other network reachable site, then automatically install into memory, and is started. In this manner the number of clients can increase during the time leading up to the event initiation without having to restart the plurality of clients when a new client is added to the client group.

### V.4 Alternate Latency Discovery Methods

According to a further embodiment of the present invention, the client device, through the use of the client device software SWC, utilizes a process that is known as “pinging the server” by those skilled in the art of computer networking Pinging is a specific procedure which utilizes very small data packets to request transit time information from a specific server on the network. In this further embodiment, the client device does not keep track of the time while waiting for the task server reply or use the TPRC value from the task server as used in eqn. 5 to calculate TT1[i] 506, in the primary embodiment. Rather, the Latency Discovery step 302 is modified to first perform several “ping” requests to the task server to directly gather the set of values representing TT1[i], instead of TR 506. Then used in the statistical analysis of the primary embodiment to obtain the one way transit time, TT1, and the margin of error ME_{CL}. In this further embodiment, a request is still required to be sent to the task server in order to acquire the event initiation timing information, T0S, for the subsequent calculation of the value for T0I 306 & 511. In the subsequent time synchronization steps 308 during the Countdown stage 204 & 305 only the value of T0S is required as a return value. In an even further embodiment, the process of pinging the task server is also performed during the course of the Countdown stage 204 & 305 to verify the network integrity such as in cases when network access is not consistent, as would be suggested by a high value of ME_{CL} as compared to TWIN/2.

According to a yet further embodiment, the use of a single pinging step during the Countdown stage 305 at time synchronization steps 308b to 308n is performed as a verification of the network latency variability.

### V.5 Timing Improvements

The primary embodiment incorporates a basic method and system to easily achieve the minimal goal of a one half (½) second or less window of simultaneity, TWIN. Further embodiments exist that incorporate slight permutations of the primary embodiment and small modifications primary embodiment that assist in achieving smaller windows of simultaneity.

V.5.a Extracting Timestamp Information from Data Packet Header

Depending on the network protocol being used, data packet headers may contain timestamp information that marks the time when the packet was sent. Such information can be used to track the timing of the transmissions between each client and the task server. According to a further embodiment of the present invention, the task server extracts the timestamp information from the client request packets, and includes that information in the data packet body as the value of TPRC. When the client receives the reply from the task server, the client extracts the timestamp data from the data package header of the reply, which represents the time the reply was sent. The client then computes the difference between the included value of TPRC and that extracted time to determine the task server processing time. The advantage of this embodiment over that of the primary embodiment may not be substantial, however as this particular further embodiment lacks the need for the task server to keep track of the processing time explicitly, it adds the requirement of package header extraction.

### V.5.b Higher Timing Precision

Device timing mechanisms can have microsecond 0.000001 (10⁻⁶) and even less than nanosecond (10⁻⁹) time step precisions. This implies that the window of simultaneity among the plurality of participating clients may be more accurate than the millisecond (10⁻³) time scale described herein. Although technically possible, the reaction time of the peripheral components of a common client device typically will not be comparable to 10⁻⁶ seconds due to other tasks the device may be required to perform, as understood by those familiar with the art. However, according to a further embodiment of the present invention, smaller values of TWIN are achieved using specially designed devices that are used for client devices which operate especially fast, that is, the client devices possess faster circuitry and peripheral technology that is designed to purposefully react quickly to the software controlling the activity of the event. This may also be achieved if the client device is a very simplified version of common technology, that is, a device that has a minimal number of background tasks and processes occurring that would slow the reaction speed of the device. In these particular embodiments, timing precisions less than 10⁻⁶ seconds are used to achieve extremely short windows of simultaneity, TWIN, that is, values of TWIN much shorter than one (1) second may be achieved using this method and system. When client devices such as this are used, the nature of the network latency variance will become increasingly the limiting factor to producing simultaneous events over a network.

### V.5.c Increasing Statistical Accuracy

The number NS, equal to five (5) acquisitions during the Latency Discovery step 302 is chosen for the primary embodiment as a reasonable number to obtain a good approximation of the network latency variance while minimizing the burden on the task server. Further embodiments of the present method and system, use more than five (5) timing requests during a Latency Discovery step 302 to achieve the margin of error. Although five (5) is enough reasonably determine the statistics for a common network, ten (10) or more timing requests to gather data for the statistical analysis to determine ME_{CL} may be needed for networks with higher latency variability. The use of the method and system will determine the required accuracy of the statistics, which can be judged by those familiar in the art of statistics. According to a yet further embodiment, if the margin of error, ME_{CL} is too high, that is ME_{CL} is greater than TWIN/2, then additional timing requests are made to verify the statistics.

### V.6 Poor Transit Time Variance

Several options exist for when poor transit time variance is discovered, that is when ME_{CL} is greater than TWIN/2 for a client. Further embodiments of the present invention incorporate the options for the client software to retry the Latency Discovery step 302, add extra Latency Discovery steps during the Countdown stage 204 & 305, at the time synchronization points 308b to 308n, and displaying a message asking for human input to dictate what action to take, such as to retry another Latency Discovery step or simply retire from the client group.

### V.7 Validity Checking

According to further embodiments of the present invention, the software of both the task server, SWT, and the client devices, SWC, incorporate checks to verify that the variable values and calculated results are valid. An example of such is to verify that TE and T0S1 405 represent times that are in the future. Other checks may include security aspects, such as if a use of the present invention requires secure connections, or a form of coding such as encryption, as understood by those skilled in the art of secure networking. The steps to perform such checks, although not included in the flowcharts of the task server and the client devices, FIGS. 4 and 5 respectively, can be included in a straight forward way by those familiar in the art of computer programming.

V.8 Pre-event initiation

According to a further embodiment of the present invention, referring to FIG. 3, the point along the timeline when T0 equals TB 314, the buffer length of time just before the event initiation, the client device performs last second preparations required for the activity. In particular, if the activity requires video or audio, this is the time when the software loads it into memory so that the reaction time of the device is minimized at event initiation 315. According to a yet further embodiment, the device shows a countdown screen for the human operator to prepare something required for the activity associated with the event initiation.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

I claim:

1. A method for causing concurrent events to take place within a specified span of time across at least two devices comprising:
a task server computer connected to a network;
the task server computer running a server application in communication with the network;
the at least two devices comprising a client group;
the client group running a client application in communication with the network;
wherein the at least two devices comprising the client group are at least one of the following: cell phone, PDA, tablet, computer, smartphone, smartwatch, laptop, portable computing device with network capabilities;
the at least two devices performing a time synchronization data exchange with the task server computer to determine network latency;
the at least two devices determining the network latency variance based on data from the time synchronization data exchange;
the task server computer determining the number of devices that can be efficiently processed;
each device of the at least two devices independently determining a best window of simultaneity;
wherein the event will occur across the at least two devices during a period of time indicated by an established window of simultaneity;
the client application sending timing request to the task server to collect data for use in the statistical evaluation of the network latency variance to verify that the at least one device of the client group is expected to achieve the window of simultaneity;
the task server computer establishing an event initiation time via the client application;
the at least two devices of the client group periodically synchronizing the event initiation time relative to the time kept by the task server computer by performing an additional time synchronization data exchange with the task server;
the at least two devices performing independent internal clock countdowns leading up to an event initiation time;
the at least two devices independently initiating the event via the client application after the event initiation time is reached; and
the at least two devices independently reporting the status of the event to the task server computer via communication between the client application and the server application upon event execution.

2. The method of claim 1, further comprising the task server computer and the at least two devices of the client group performing calculations used to determine the window of simultaneity and executing timing operations that are performed independently by an onboard process within each independent device of the at least two devices of the client group.

3. The method of claim 1, further comprising the task server maintaining an accurate timepiece synchronized with a precise clock.

4. The method of claim 1, further comprising the task server maintaining a relative time relationship with the client group.

5. The method of claim 1, wherein the time synchronization data exchange is performed by each individual device of the at least two devices of the client group and the task server computer at specified intervals, ensuring consistent calculations of the window of simultaneity for the event over extended periods of time; and,
wherein each independent device of the at least two devices of the client group does not communicate directly with other independent devices of the at least two devices of the client group.

6. The method of claim 1, wherein the simultaneous execution of the event across the at least two devices of the client group is only enacted by devices of the client group that meet predefined qualifications established by the task server computer.

7. The method of claim 2, wherein a time synchronization data exchange is performed by each individual device of the multiple devices of the client group with the task server at specified intervals, ensuring consistent calculations of the window of simultaneity for the event over extended periods of time; and
wherein each independent device of the multiple devices of the client group does not communicate with the multiple devices of the client group.

8. The method of claim 1, wherein the at least two devices of the client group synchronize time with the task server computer based on a Network Timing Protocol (NTP) server clock.

9. The method of claim 1, wherein said the task server computer establishing an event initiation time via the client application is initiated via user input.

10. A system for executing an event on multiple network-connected devices over a network comprising:
a task server computer connected to the multiple network-connected devices via the network;
a server application, said server application running on said task server and interfaced with said network;
a client application, said client application running on said multiple network-connected devices;
wherein said client application is configured to connect to the server application via the network;
wherein said multiple network-connected devices comprise a client group;
wherein said multiple network-connected devices include at least one individual device;
wherein said multiple network-connected devices are at least one of the following: cell phone, PDA, tablet, computer, smartphone, smartwatch, laptop, portable computing device with network capabilities;
wherein said at least one individual device is configured to determine a latency variance of the network connection between said at least one individual device and said task server;
wherein said task server computer is configured to determine the maximum number of individual devices that can be efficiently processed;
further comprising said at least one individual device is configured to determine a best window of simultaneity, wherein the event will ideally occur across said multiple network-connected devices within the time span defined by the longest window of simultaneity of the set of devices; wherein said multiple network-connected devices are configured to synchronize relative time with said task server;
wherein said client application is configured to perform at least one time synchronization data exchange with said task server to collect data for use in a statistical evaluation of said network latency variance to verify that said at least one individual device is expected to achieve the window of simultaneity;
wherein said task server computer is configured to establish an event initiation time according to input from a user;
wherein said multiple network-connected devices are configured to periodically synchronize said event initiation time relative to a time maintained by said task server by sending time request data to said task server during the time synchronization data exchanges;
wherein said at least one individual device is configured to autonomously initiate the event after said at least one individual device has performed an internal clock countdown subsequent to a final time synchronization data exchange with said task server;
wherein said multiple network-connected devices employ a non-transitory computer readable medium; and
wherein said multiple network-connected devices are configured to execute the event simultaneously and report a status of the event to said task server.

11. A system for simultaneously executing an event on multiple network-connected devices over a network comprising:
a task server computer connected to the multiple network-connected devices via the network;
a server application, said server application running on said task server and interfaced with said network;
a client application, said client application running on said multiple network-connected devices;
wherein said client application is configured to connect to the server application via the network;
wherein said multiple network-connected devices comprise a client group;
wherein said multiple network-connected devices include at least one individual device;
wherein said multiple network-connected devices are at least one of the following: cell phone, PDA, tablet, computer, smartphone, smartwatch, laptop, portable computing device with network capabilities;
wherein said at least one individual device is configured to determine a latency variance of the network connection between said at least one individual network-connected device and said task server;
wherein said task server computer is configured to determine the maximum number of individual devices that can be efficiently processed;
further comprising said at least one individual device is configured to determine a best window of simultaneity, wherein the event will ideally occur across said multiple network-connected devices simultaneously;
wherein said multiple network-connected devices are configured to synchronize time with said task server;
wherein said client application is configured to send a timing request to said task server to collect data for use in a statistical evaluation of said network latency variance to verify that said at least one individual device is expected to achieve the window of simultaneity;
wherein said task server computer is configured to establish an event initiation time according to input from a user;
wherein said multiple network-connected devices are configured to periodically synchronize said event initiation time relative to a time maintained by said task server by sending time request data to said task server, then receiving synchronization data from said task server;
wherein said at least one individual device is configured to autonomously initiate the event after said at least one individual device has performed an internal clock countdown subsequent to a final time synchronization data exchange with said task server;
wherein said multiple network-connected devices employ a non-transitory computer readable medium; and
wherein said multiple network-connected devices are configured to execute the event simultaneously and report a status of the event to said task server.

12. A method for simultaneously executing an event on multiple devices via a network comprising:
a task server computer running a server application in communication with the network;
the multiple devices loading a client application software;
the multiple devices executing the client application software;
the client application software interfacing with the task server computer;
the client application software performing at least 3 time synchronization data exchanges between the task server computer and the multiple devices to discover latency between the task server computer and the multiple devices;
wherein the at least 3 time synchronization data exchanges are initiated by the multiple devices;
wherein the multiple devices are composed of individual devices including at least one of the following: cell phone, PDA, tablet, computer, smartphone, smartwatch, laptop, portable computing device with network capabilities;
the multiple devices determining an event initiation time for each individual device via the at least 3 time synchronization data exchanges;
wherein maintaining the event initiation time is managed in sync with relative time;
further comprising the latency discovery yielding an average latency time for each device of the multiple devices;
the multiple devices initiating the event concurrently as instructed by the client application software in communication with the task server; and
the multiple devices sending a completion message to indicate success to the task server.

13. A method for simultaneously executing an event on mobile devices comprising:
a pre-countdown stage comprising:
a task server computer interfacing with at least one mobile device via a client application over a network;
the at least one mobile device performing at least three time synchronization data exchanges with the task server over the network;
the at least one mobile device determining the average network latency between the at least one mobile device and the task server;
the at least one mobile device determining the latency variance of the network using data from the at least three time synchronization data exchanges.
the at least one mobile device determining the margin of error based on data from the at least three time synchronization data exchanges;
the at least one mobile device and the task server calculating a window of simultaneity based on the margin of error over network conditions;
the at least one mobile device determining the relative time until an event initiation with an internal clock of the at least one mobile device based on a synchronization of relative time with an internal clock of the task server;
a countdown stage, comprising:
the at least one mobile device performing additional time synchronization data exchanges with the task server;
the at least one mobile device establishing parameters an event imminent stage comprising:
the at least one mobile device performing a final time synchronization data exchange with the task server over the network;
an event initiation stage comprising:
the at least one mobile device initiates the event as instructed by the client software; and
a reporting stage comprising:
the at least one mobile device sending a message to the task server to confirm the success of the event.
